(19) United States
(12) Patent Application Publication
(10) Pub. No.: US 2011/0226996 A1
(43) Pub. Date: Sep. 22, 2011

(54) LUMINESCENT PAINTS AND METHODS OF MAKING THE SAME

(76) Inventor: David Postma, Hobart, IN (US)

(21) Appl. No.: 13/130,700

(22) PCT Filed: Nov. 24, 2009
(86) PCT No.: PCT/US2009/065674

§ 371 Date: May 23, 2011

Related U.S. Application Data
(60) Provisional application No. 61/117,698, filed on Nov. 25, 2008.
(60) Provisional application No. 61/151,068, filed on Feb. 9, 2009.

(51) Int. Cl. C09D 5/22; C09K 11/02; C09K 11/80

(52) U.S. Cl. 252/301.36

(57) ABSTRACT

Luminescent paints and methods of making luminescent paints are provided. In some examples, the luminescent paints may include urethane resin and luminescent substance. The luminescent paints may also include a variety of day time, UV stable colors and a flex agent that facilitates dependable application of the luminescent paint to flexible objects.

### RELATED APPLICATIONS

The present application claims the benefit of co-pending U.S. Provisional Patent Application Nos. 61/117,698, filed Nov. 25, 2008, and 61/151,068, filed Feb. 9, 2009, the entire contents of both are hereby incorporated herein by reference.

### FIELD OF THE INVENTION

The present invention generally relates to luminescent paints and, more particularly, to urethane based luminescent paints.

### BACKGROUND

Conventional luminescent paints are typically acrylic in nature and may either be water or solvent based acrylics. Due to the nature of acrylic based luminescent paints, these luminescent paints lack durability and are brittle when dry. When applied to a surface, these acrylic based luminescent paints wear quickly or may begin to crack, flake, peel, or crumble, and therefore chip away. In addition, the color capabilities of acrylic based luminescent paints are limited because the water based dyes compatible with such acrylic based luminescent paints are not ultraviolet (UV) stable and will fade in a relatively short period of time (e.g., 2 months) with exposure to ultraviolet rays (e.g., sunlight or artificial light). Some acrylic based luminescent paints may include a UV inhibitor to inhibit fading of the color. However, such UV inhibitors reduce the effectiveness of the luminescent aspect of the paint because the UV rays are required to activate the luminescent substance within the paints and the UV rays cannot access the luminescent substance due to the UV inhibitor.

The types of surfaces to which acrylic based luminescent paints may be applied are limited by the characteristics of these paints. For example, due to the low durability of acrylic based luminescent paints, it is undesirable to apply these luminescent paints in high traffic areas. Also, for example, due to the brittleness of the acrylic based luminescent paints, it is undesirable to apply these luminescent paints to objects that may flex or otherwise deform, or to objects that may be impacted. Application of conventional luminescent paints to such objects will cause the conventional luminescent paints to flex, crack or break, and ultimately chip away.

### SUMMARY

The present invention resolves shortcomings of the prior art.

In one example, a luminescent paint is provided.

In another example, a method of making a luminescent paint is provided.

In a further example, a urethane based luminescent paint is provided.

In yet another example, a method of making a urethane based luminescent paint is provided.

In yet a further example, a urethane based luminescent paint is provided and includes a urethane base, an anti-settling agent, and a luminescent substance.

In still another example, a method of making a luminescent paint is provided and includes providing a quantity of an anti-settling agent, mixing a quantity of urethane base with the quantity of anti-settling agent, and mixing a quantity of luminescent substance with the mixture of anti-settling agent and urethane base.

In a still further example, a luminescent paint composition is provided and includes urethane resin and luminescent substance.

In another example a luminescent paint is provided and includes a composition comprising, as a percentage by weight, about 10% to about 37% urethane resin and about 10% to about 35% luminescent substance.

In a further example, a luminescent paint is provided and includes a composition comprising, as a percentage by weight, about 15% to about 27% urethane resin, about 10% to about 20% anti-settling agent, about 0.2% to about 4% dye, and about 17% to about 23% luminescent substance.

### BRIEF DESCRIPTION OF THE DRAWINGS

FIG. 1 is a perspective view of an exemplary environment in which urethane based luminescent paint embodying the present invention may be applied, the exemplary environment comprising a building stairwell including stairs, a handrail, a landing, a riser, a door frame, and a sign;

FIG. 2 is another perspective view of another exemplary environment in which the urethane based luminescent paint may be applied, the environment comprising a hard hat;

FIG. 3 is a cross-sectional schematic of an exemplary application of the urethane based luminescent paint to an exemplary object;

FIG. 4 is a flowchart illustrating an exemplary manner of making a urethane based luminescent paint;

FIG. 5 is a flowchart illustrating another exemplary manner of making a urethane based luminescent paint;

FIG. 6 is a flowchart illustrating yet another exemplary manner of making a urethane based luminescent paint;

FIG. 7 is a flowchart illustrating a further exemplary manner of making a urethane based luminescent paint; and

FIG. 8 is a flowchart illustrating still a further exemplary manner of making a urethane based luminescent paint.

Before any independent features and embodiments of the invention are explained in detail, it is to be understood that the invention is not limited in its application to the details of the construction and the arrangement of the components set forth in the following description or illustrated in the drawings. The invention is capable of other embodiments and of being practiced or of being carried out in various ways. Also, it is understood that the phraseology and terminology used herein is for the purpose of description and should not be regarded as limiting.

### DETAILED DESCRIPTION

Luminescent paints of the present invention are usable in a variety of different applications and may be applicable to a variety of different objects and materials. The luminescent paints absorb and in return emit light, which may be helpful for illuminating environments having low light conditions, and are durable, thereby resisting wear and providing a long effective life. Also, the luminescent paints may have a variety of colors capable of maintaining their vividness after being exposed to light for lengthy periods of time. Such luminescent paints comprise a urethane base. The use of the urethane base provides the luminescent paints with improved durability and improved impact resistance over conventional acrylic based luminescent paints. In addition, urethanes have been proven to have superior structural flexibility, superior bonding, superior compatibility with other products (e.g., primers, top coats, etc.), and a significantly longer life then acrylics based paints. Further, the present urethane based luminescent paints may be applied to surfaces in a wider range of climate conditions. For example, the urethane based luminescent paints may be effectively applied to surfaces in relatively low temperatures such as below 50° Fahrenheit. If acrylic based luminescent paints are applied to surfaces at temperatures below 50° Fahrenheit, the paint will not cure. Further yet, the urethane based luminescent paints may have a wide variety of colors resistant to fading.

The urethane based luminescent paints include a luminescent substance that provides the luminescent properties of the luminescent paints. The luminescent substance may be a variety of different substances such as, for example, strontium aluminate doped with europium (SrAl₂O₄:Eu) or copper-activated zinc sulfide (ZnS:Cu). In some examples, the urethane based luminescent paints may also include an anti-settling agent. The anti-settling agent inhibits the particulate within the paint from settling to a bottom of a container and solidifying to an extent where the paint is unusable. Also, in some examples, the urethane based luminescent paints may include dyes for coloring the luminescent paint to desired colors. Exemplary colors include, but are not limited to, blue, light blue, green, light green, blue-green, yellow, fluorescent yellow, orange, purple, and red. In some instances, it may be desired for the luminescent paints to be white in color, in which case no dye is added to the paints. Further, in some examples, the urethane based luminescent paints may include a flex agent that enables the urethane based luminescent paints to be applied to flexible or semi-flexible objects and withstand flexing of the objects or impacts to the objects without cracking, chipping, or peeling of the paint from the objects. Conventional acrylic based luminescent paints are very brittle and crack, chip, or peel when applied to flexible or semi-flexible objects. The flex agent reduces the brittleness of the urethane based luminescent paints, thereby providing the urethane based luminescent paint with sufficient elasticity to accommodate flexing of the object. A variety of flex agents may be utilized in the urethane based luminescent paints of the present invention.

The urethane based luminescent paints may be used in a variety of exemplary applications such as, for example: floors; walls; handrails; doors; door frames; base boards; stairs; various interior and exterior portions of automobiles and other motorized vehicles such as wheel rims, body paint, truck beds, calipers, etc.; various interior and exterior portion of trailers and other non-motorized vehicles; heavy machinery or equipment; personal safety equipment such as hard hats; transformers; power boxes; electric service panels; tool boxes; fire hydrants; fire extinguishers; fire extinguisher cabinets; parking lot indicia; roadway indicia; airport runway indicia; bicycle path indicia; exterior and interior portions of buildings; floor boards; light fixtures; bollards; construction related implements such as road cones, barrels, barriers and J-walls; various interior and exterior portions of police and fire departments; etc. In addition, the urethane based luminescent paints may be applied to a variety of different materials such as, for example, metal, plastic, concrete, asphalt, drywall, glass, wood, ceramics, porcelain, etc.

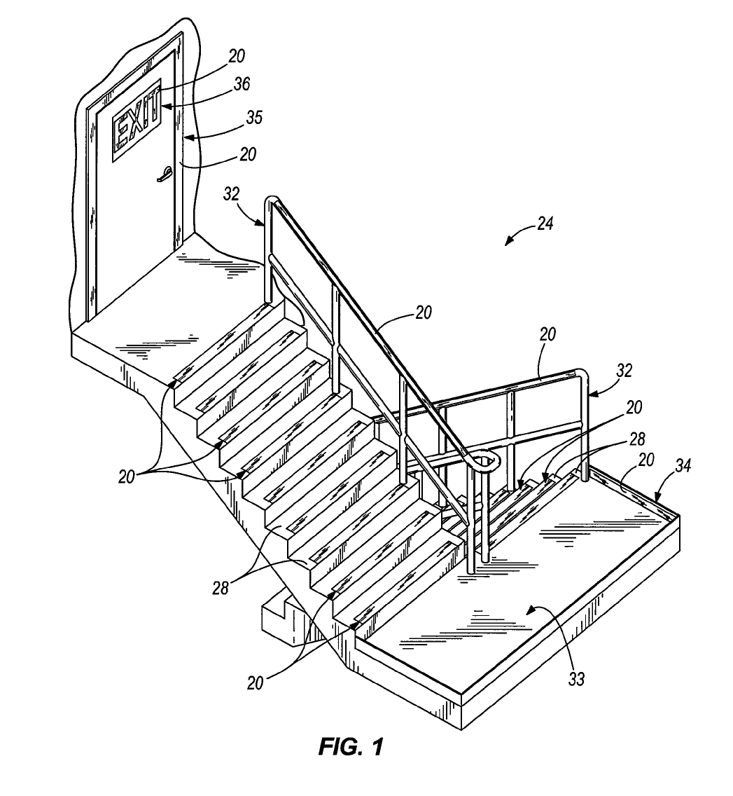

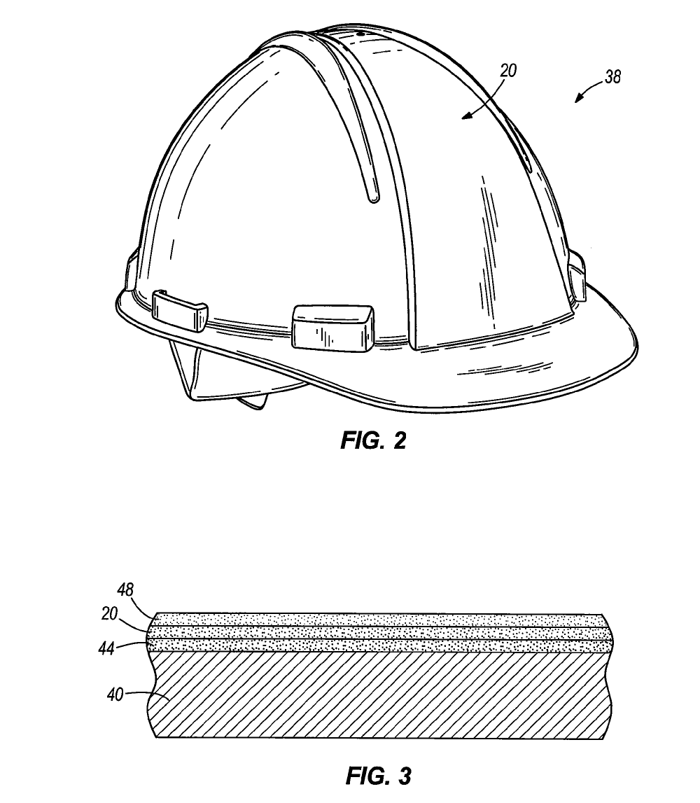

With reference to FIGS. 1 and 2, exemplary applications of urethane based luminescent paints 20 of the present invention are illustrated. More particularly, FIG. 1 illustrates a stairwell 24 in an interior of a building. The luminescent paint 20 may be applied to the stairs 28, the handrail 32, a landing 33, a riser 34, a doorframe 35, and a sign 36. Stairwells 24 are often low light environments under normal conditions. In emergency situations, such as in a fire or a loss of electricity, the stairwell 24 has even lower light conditions than under normal conditions. In such instances, the light emitted by the luminescent paint 20 on the stairs 28, handrails 32, landing 33, riser 34, door frame 35, and sign 36 may illuminate the stairwell 24 and make it easier for occupants in the stairwell 24 to see the stairs 28, the handrails 32, etc., and other people within the stairwell 24. The luminescent paint 20 is durable and provides a long life on the stairs 28 under heavy foot traffic and on the handrail 32 under heavy hand traffic.

With reference to FIG. 2, a hard hat 38 is illustrated and includes the urethane based luminescent paint 20 on at least an exterior of the hard hat 38. The urethane based luminescent paint may also be applied to an interior of the hard hat 38. Hard hats 38 are typically made of a hard, durable plastic capable of enduring impacts. The luminescent paint 20 is capable of adhering to the material of the hard hat 38 without peeling, cracking, or chipping. Hard hats 38 may be worn in a variety of environments, some of which have low light conditions. In such low light conditions, light emitted by the luminescent paint 20 will increase the hard hat's 38 visibility, thereby inhibiting the occurrence of accidents.

As indicated above, the urethane based luminescent paints of the present invention are capable of having a variety of colors, often referred to as daytime colors, that resist fading. Dyes may be used to color the urethane based luminescent paints and such dyes may be, for example, solvent or petroleum based in order to be compatible with the urethane based luminescent paints. Alternatively, the dyes may be other based dyes that are compatible with the urethane based luminescent paints. Solvent, petroleum, and other based dyes resist fading when exposed to ultraviolet (UV) rays, thereby providing the urethane based luminescent paints containing these types of dyes with colors that have the ability to resist fading. This is contrary to conventional acrylic based luminescent paints, which require water based dyes for compatibility. Such water based dyes are not UV tolerant and will fade easily when exposed to UV rays. The urethane based luminescent paints of the present invention may have colors including, for example, blue, light blue, green, light green, blue-green, yellow, fluorescent yellow, orange, purple, red, and white, that resist fading and have a relatively long, colorful life.

Referring now to FIG. 3, an exemplary application of the urethane based luminescent paints 20 of the present invention is illustrated and will be described herein. This exemplary application is only one of a variety of different manners for applying the luminescent paints 20 to an object 40. In this example, a primer or first coat 44 is applied directly to an object 40. Since the luminescent paint of the present invention is urethane based, the luminescent paint is compatible with a wide variety of primer types such as, for example, acrylic, alkyd, enamels, urethane, epoxy, etc. Also, the primer coat 44 should be in good condition (i.e., not chipping, cracking, or peeling; free of dirt, oil, grease, and other foreign materials). In some examples, it is preferable that the primer coat 44 have a white or light silver color (described in greater detail below). Next, the urethane based luminescent paint 20 may be applied onto the primer coat 44. In some instances, the urethane based luminescent paint 20 may be referred to as the mid-coat. In the illustrated exemplary embodiment, a single coat or layer of urethane based luminescent paint 20 is applied. Alternatively, any number of coats or layers of urethane based luminescent paint 20 may be applied and be within the spirit and scope of the present invention. Finally, a top coat or clear coat 48 may be applied onto the luminescent paint 20. In some examples, the clear coat 48 may be non-yellowing with low UV inhibitors to allow maximum UV penetration therethrough. Also, in some examples, the clear coat 48 may be urethane based, epoxy based, alkyd based, etc. The clear coat 48 may also provide some protection to the luminescent paint 20, thereby improving the paint's 20 overall durability.

In the present example, the luminescent paint 20 is applied to a primer 44. The primer 44 may be a variety of colors, but, typically, primer 44 is white. While the urethane based luminescent paint 20 may be applied to primer 44 having any color, applying the urethane based luminescent paint 20 to a white primer 44 may accentuate the brightness and the color of the luminescent paint 20. Silver is another color that may accentuate the brightness and the color of the luminescent paint 20. These particular primer colors and other similar colors may reflect UV rays that have passed through or by the urethane based luminescent paint 20 back through the paint 20 to increase the paint's 20 exposure to UV rays, thereby improving charging of the luminescent substance within the paint 20.

The urethane based luminescent paint 20 may also be applied directly to an object 40 without a primer layer. While the luminescent paint 20 may be applied to objects 40 having any color, objects 40 having a white or silver color accentuate the brightness and color of the luminescent paint 20 more than other colors for reasons similar to those described above relating to primer colors.

The following description identifies exemplary compositions of and methods of making urethane based luminescent paints of the present invention. The following examples are not meant to be limiting upon the present invention and the urethane based luminescent paints of the present invention are capable of having other compositions.

A first exemplary urethane based luminescent paint includes a urethane base, an anti-settling agent, and a luminescent substance. The urethane base may be a variety of available urethane bases and may include a urethane resin and at least one solvent. In the present example, the urethane base may be UBC-825 mid-coat urethane clear sold by Kustom Shop, which is owned by TPC Global of San Diego, Calif. 92121. Alternatively, the urethane base may be SG-150 mid-coat urethane clear sold by House of Kolor of Picayune, Miss. 39466 or MC014 mid-coat urethane clear sold by SEM Products of Charlotte, N.C. 28217. Also in the present example, the anti-settling agent may be Y25X anti-settling product manufactured by Southern Clay Products, Inc. of Gonzales, Tex. 78629. Alternatively, the anti-settling agent may be Y-20XP also manufactured by Southern Clay Products, Inc. or Disparlon 4200-20 manufactured by King Industries of Norwalk, Conn. Further in the present example, the luminescent substance may be strontium aluminate europium and may be one of a variety of products manufactured by MPK Co. of Clayton, Wis. Such examples of the luminescent substance may be comprised of the following MPK Co. products: MMHSB-8D; MMHSB-9D; MMHSB-9C; MMHB-4B; MMHG-5B; MMSWW-4D. In these luminescent substance examples, the number immediately following the “-” in the product numbers represents a color and the letter following the number represents the size of the luminescent substance particle. For example, the letter “B” represents the largest particle size and the letter “E” represents the smallest particle size with the letters between “B” and “E” representing particle sizes decreasing in size from “B” to “E”. The larger the luminescent substance particle size the longer and brighter the luminescent substance particle will emit light. Different luminescent substance particle sizes are used for different colors of this first exemplary luminescent paint. The luminescent substance particle size selected for each color of paint was selected because it performed best with that particle color. Alternatively, the present example may include luminescent substance products manufactured by other entities such as WGR1-OW-12-18 manufactured by Color Technology of Howell, N.J. 07731 or MR-1 manufactured by Yangzhou Huahan Plastic Colour Masterbatch Co. Ltd. of Yangzhou City, Jiangsu Province, China.

The urethane based luminescent paint of this first example may have a variety of different colors and the compositions of the luminescent paint differ depending on the desired color. Dyes may be added to the urethane based luminescent paint in order to establish a desired color other than white. A variety of different types of dyes may be used to obtain the desired color of the urethane based luminescent paint. The dyes identified below are for exemplary purposes and are not intended to be limiting upon the present invention.

This first exemplary urethane based luminescent paint may be applied to a large variety of objects. Exemplary applications in which this first luminescent paint may be particularly effective may include, for example, automobiles and other motorized vehicles, trailers and other non-motorized vehicles, heavy machinery, bollards, construction objects such as road cones, barrels, barriers, etc.

The following exemplary colors and compositions are for illustrative purposes only and provide only some of the many possible colors and compositions.

If a white urethane based luminescent paint is desired, the paint may include the following quantities of components: 96 liquid ounces of urethane base, 32 liquid ounces of anti-settling agent, and 1 kilogram of MMSWW-4D luminescent substance. As indicated above, dye may not be added if white is the desired color of the luminescent paint.

If a blue urethane based luminescent paint is desired, the paint may include the following quantities of components: 90 liquid ounces of urethane base, 32 liquid ounces of anti-settling agent, 6 liquid ounces of 03238 dye manufactured by SEM Products, and 1 kilogram of MMHSB-8D luminescent substance.

If a light blue urethane based luminescent paint is desired, the paint may include the following quantities of components: 93 liquid ounces of urethane base, 32 liquid ounces of anti-settling agent, 3 liquid ounces of 03238 dye manufactured by SEM Products, and 1 kilogram of MMHSB-9C luminescent substance.

An alternative light blue urethane based luminescent paint includes similar quantities of components as the previous light blue paint, however, this alternative light blue paint includes an alternative luminescent substance. More particularly, this alternative light blue paint includes 1 kilogram of MMHSB-9D luminescent substance.

If a green urethane based luminescent paint is desired, the paint may include the following quantities of components: 90 liquid ounces of urethane base, 32 liquid ounces of anti-settling agent, 6 liquid ounces of 03248 dye manufactured by SEM Products, and 1 kilogram of MMHG-5B luminescent substance.

If a light green urethane based luminescent paint is desired, the paint may include the following quantities of components: 93 liquid ounces of urethane base, 32 liquid ounces of anti-settling agent, 3 liquid ounces of 03248 dye manufactured by SEM Products, and 1 kilogram of MMHG-5B luminescent substance.

If a blue-green urethane based luminescent paint is desired, the paint may include the following quantities of components: 90 liquid ounces of urethane base, 32 liquid ounces of anti-settling agent, 6 liquid ounces of 03238 dye manufactured by SEM Products, and 1 kilogram of MMHB-4B luminescent substance.

If a fluorescent yellow urethane based luminescent paint is desired, the paint may include the following quantities of components: 90 liquid ounces of urethane base, 32 liquid ounces of anti-settling agent, 6 liquid ounces of 03278 dye manufactured by SEM Products, and 1 kilogram of MMSWW-4D luminescent substance.

An alternative fluorescent yellow urethane based luminescent paint includes similar quantities of components as the previous fluorescent yellow paint, however, this alternative fluorescent yellow paint includes an alternative luminescent substance. More particularly, this alternative fluorescent yellow paint includes 1 kilogram of MMSWW-4D luminescent substance.

If a yellow urethane based luminescent paint is desired, the paint may include the following quantities of components: 90 liquid ounces of urethane base, 32 liquid ounces of anti-settling agent, 6 liquid ounces of Planet Color PCLD5 dye manufactured by Sherwin-Williams Automotive Finishes Corp. of Cleveland, Ohio, and 1 kilogram of MMHG-5B luminescent substance.

An alternative yellow urethane based luminescent paint includes similar quantities of components as the previous yellow paint, however, this alternative yellow paint includes an alternative luminescent substance. More particularly, this alternative yellow paint includes 1 kilogram of MMSWW-4D luminescent substance.

If an orange urethane based luminescent paint is desired, the paint may include the following quantities of components: 90 liquid ounces of urethane base, 32 liquid ounces of anti-settling agent, 6 liquid ounces of Planet Color PCLD5 dye manufactured by Sherwin-Williams Automotive Finishes Corp. of Cleveland, Ohio, 16 grams of Parasol Red EG Solvent Red 135 manufactured by Paramount Colors Inc. of Elk Grove Village, Ill. 60007, and 1 kilogram of MMHG-5B luminescent substance.

An alternative orange urethane based luminescent paint includes similar quantities of components as the previous orange paint, however, this alternative orange paint includes an alternative luminescent substance. More particularly, this alternative orange paint includes 1 kilogram of MMSWW-4D luminescent substance.

Another alternative orange urethane based luminescent paint includes similar quantities of components as the previous orange paints, however, this alternative orange paint includes a combination of luminescent substances to arrive at the 1 kilogram of total luminescent substance mass. More particularly, this alternative orange paint includes 0.75 kilograms of MMSWW-4D luminescent substance and 0.25 kilograms of WGR1-OW-12-18 Color Technology luminescent substance.

In further alternative orange urethane based luminescent paints, other types of dyes may be used to color the paint a desired color. Such dyes may include, for example, Parasol BK 196, Parasol GK 197, Parasol AB23, and Parasol A 24, all of which are manufactured by Paramount Colors Inc. of Elk Grove Village, Ill. 60007.

If a purple urethane based luminescent paint is desired, the paint may include the following quantities of components: 90 liquid ounces of urethane base, 32 liquid ounces of anti-settling agent, 4 liquid ounces of 03238 dye manufactured by SEM Products, 2 liquid ounces of Planet Color PCLD8 dye manufactured by Sherwin-Williams Automotive Finishes Corp. of Cleveland, Ohio, 0.75 kilograms of MMHSB-9D luminescent substance, and 0.25 kilograms of WGR1-OW-12-18 Color Technology luminescent substance.

If a red urethane based luminescent paint is desired, the paint may include the following quantities of components: 96 liquid ounces of urethane base, 32 liquid ounces of anti-settling agent, 16 grams of Parasol Red PH manufactured by Paramount Colors Inc. of Elk Grove Village, Ill. 60007, 0.30 kilograms of WGR1-OW-12-18 Color Technology luminescent substance, and 0.70 kilograms of MR-1 Yangzhou Huahan Plastic Colour Masterbatch luminescence substance.

In alternative red urethane based luminescent paints, other types of dyes may be used to color the paint a desired color. Such dyes may include, for example, Parasol BK 196, Parasol GK 197, Parasol AB23, and Parasol A 24, all of which are manufactured by Paramount Colors Inc. of Elk Grove Village, Ill. 60007.

In some exemplary embodiments, another substance or filler may be added to the urethane based luminescent paint in order to provide additional beneficial characteristics to the urethane based luminescent paint. Such beneficial characteristics may include, for example, thickening the paint so less coats or layers of paint are required to provide adequate coverage, increasing durability of the paint, increasing uniformity of the paint, assists with color retention, and may increase the paint's chemical and stain resistance. The filler may be a variety of different products including, for example, silica flour, Nepheline Syenite, etc. One of the many examples of silica flour useable with the urethane based luminescent paint may include silica flour provided by AGSCO of Wheeling, Ill. Two of the many examples of nepheline syenite useable with the urethane based luminescent paint may include Minex 3 and Minex 4 provided by Uninim Specialty Minerals, Inc. of New Canaan, Conn. The filler may be added to any of the exemplary urethane based luminescent paints described above and other possible urethane based luminescent paints of the present invention. Also, various quantities of filler may be added to the urethane based luminescent paint. In one exemplary embodiment, 500 grams of filler per gallon of paint may be added to the urethane based luminescent paint. In other exemplary embodiments, anywhere from 0.1 grams to 1000 grams of filler per gallon of paint may be added to the urethane based luminescent paint. Other quantities of filler are contemplated and are within the intended spirit and scope of the present invention. The full quantity of filler added to the urethane based luminescent paint may be comprised of either a single type of filler or may be comprised of multiple types of filler. For example, in instances where a single type of filler is added, the total quantity of filler may be comprised of silica flour or the total quantity of filler may be comprised of nepheline syenite. Also for example, in instances where multiple types of filler are added, a first portion of the total quantity of filler may be comprised of silica flour and the remaining portion of the filler may be comprised of nepheline syenite. The filler may also be comprised of a wide variety of different particle sizes. In some exemplary embodiments, the size of the particles comprising the filler may be between about 37 microns and about 74 microns. Other particles sizes of the filler are possible and are within the spirit and scope of the present invention. Smaller particle sizes may be desired in applications where a smooth, non-gritty urethane based luminescent paint is desired. One such exemplary application may include automotive exterior paint. Larger particle sizes may be desired in applications where a rougher, gritty, and/or anti-skid urethane based luminescent paint is desired. One such exemplary application may include steps in a stairwell.

In the above exemplary colors of the first exemplary urethane based luminescent paint, the various elements of the paint comprise the following percentages of the total weight of the paint: urethane base comprises between about 48% and about 59% of the total weight; anti-settling agent comprises between about 16% and about 20% of the total weight; dye comprises between 0% and about 4% of the total weight; luminescent substance comprises between about 17% and about 23% of the total weight; and filler comprises between 0% and about 18% of the total weight. Alternatively, the various elements of the paint may comprise other percentages of the total weight of the urethane based luminescent paint. For example, the various elements may comprise the following percentages of the total weight of the paint: urethane base may comprise between about 24% and about 95% of the total weight; anti-settling agent may comprise between about 7% and about 35% of the total weight; dye may comprise between 0% and about 10% of the total weight; luminescent substance may comprise between about 10% and about 35% of the total weight; and filler may comprise between about 0% to about 35%.

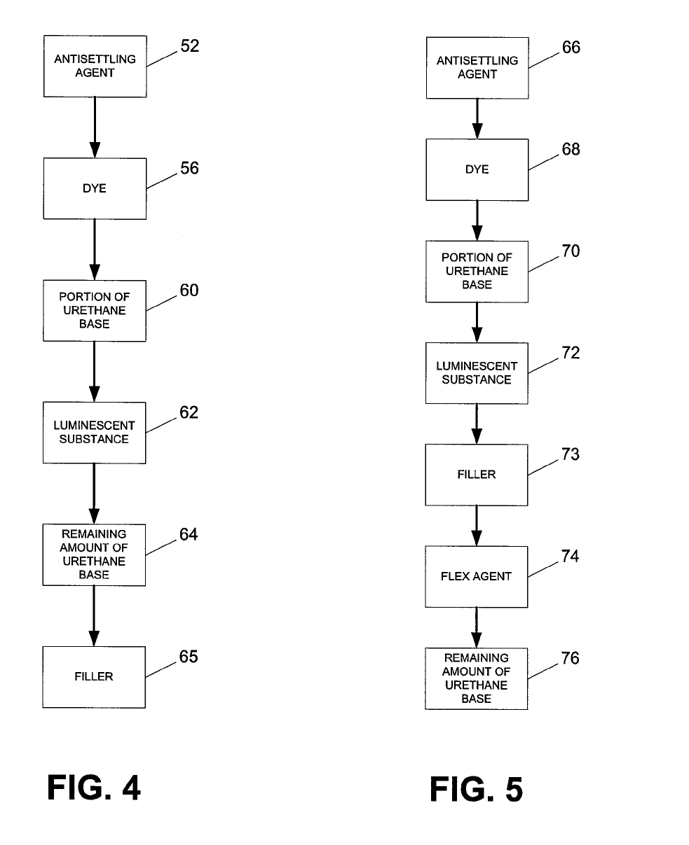

With reference to FIG. 4, an exemplary method of making the first exemplary urethane based luminescent paint in illustrated and will be described herein. This is only one of many different methods of making the first exemplary paint and this example is not intended to be limiting. Many other methods of making the urethane based luminescent paint are contemplated and are within the spirit and scope of the present invention.

The first step in this exemplary method of making urethane based luminescent paint includes beginning with the full quantity of anti-settling agent (step 52). For this first exemplary urethane based luminescent paint, the full quantity of anti-settling agent is 32 liquid ounces. Next, dye is added to the anti-settling agent if it is desired for the luminescent paint to have a color other than white (step 56). The dye added to the anti-settling agent is dependent on the desired color of the luminescent paint. If dye is added, the dye and anti-settling agent are mixed until evenly blended. The components of this urethane based luminescent paint may be mixed in a variety of manners such as, for example, stirring or shaking. In some examples, stirring may be performed with a plastic stirring element. After the dye is mixed with the anti-settling agent, a portion of the urethane base is added to the mixture of dye and anti-settling agent (step 60). A portion rather than the entirety of the urethane base is added to promote even blending of the mixture because the anti-settling agent may disperse easier in a smaller quantity of solvents than in a larger quantity of solvents. For this first exemplary urethane based luminescent paint, the full quantity of urethane base varies depending on the desired color of the luminescent paint. The first portion added to the mixture may be any portion of the full quantity of the urethane base. In one example, 32 liquid ounces of the urethane base is added to the mixture of anti-settling agent and dye, and is mixed until evenly blended. After this mixture is evenly blended, the total amount of the luminescent substance is added to the mixture of anti-settling agent, dye, and a portion of the urethane base (step 62). The luminescent substance is mixed into the mixture until it is evenly blended. After the luminescent substance is mixed into the mixture, the remaining amount of the urethane base is added to the mixture and mixed until evenly blended (step 64). Next, if desired, the full quantity of filler is added to the mixture and mixed until evenly blended (step 65). Upon creating an evenly blended mixture including all the above components, the first exemplary urethane based luminescent paint is completed. The amount of time required to make this luminescent paint may vary. In some examples, about 5 minutes of mixing may be required after each component of the paint is added to the mixture, thereby establishing a total mixing time of about 30 minutes. Other mixing times are possible and are within the intended spirit and scope of the present invention.

A second exemplary urethane based luminescent paint includes a urethane base, an anti-settling agent, a flex agent, and a luminescent substance. The addition of the flex agent to this second exemplary urethane based luminescent paint enables the paint to be applied to objects that may experience flexing or impacts and withstand the flexing of and impacts to the objects without cracking, peeling, or chipping of the paint from the objects. Conventional acrylic based luminescent paints are very brittle and crack, peel, or chip when applied to objects that may experience flexing or impacts. The flex agent reduces the brittleness of the urethane based luminescent paint, thereby providing the urethane based luminescent paint with sufficient elasticity to accommodate flexing of and impacts to the object. The urethane base of this second exemplary luminescent paint may be a variety of available urethane bases and may include a urethane resin and at least one solvent. In the present example, the urethane base may be UBC-825 mid-coat urethane clear sold by Kustom Shop. Alternatively, the urethane base may be SG-150 mid-coat urethane clear sold by House of Kolor or MC014 mid-coat urethane clear sold by SEM Products. Also in the present example, the anti-settling agent may be Y25X anti-settling product manufactured by Southern Clay Products, Inc. Alternatively, the anti-settling agent may be Y-20XP also manufactured by Southern Clay Products, Inc. In addition, in the present example, the flex agent may be manufactured by DuPont Performance Coatings of Wilmington, Del. under the product number 4150. Alternatively, other flex agents such as, for example, Pro Flex made by Carolina Auto Supply House of Charlotte, N.C. 28206, Super Sem Flex 39728 made by SEM Products, and MPC 47-474SP made by Matthews Paint of Pleasant Prairie, Wis. 53158, may be used with this urethane based luminescent paint. Further, in the present example, the luminescent substance may be strontium aluminate europium and may be one of a variety of products manufactured by MPK Co. Such examples of luminescent substance may be comprised of the following MPK Co. products: MMHSB-8D; MMHSB-9D; MMHSB-9C; MMHB-4B; MMHG-5B; MMSWW-4D. Alternatively, the present example may include luminescent substance products manufactured by other entities such as WGR1-OW-12-18 manufactured by Color Technology of Howell, N.J. 077310 or MR-1 manufactured by Yangzhou Huahan Plastic Colour Masterbatch Co. Ltd. of Yangzhou City, Jiangsu Province, China.

The urethane based luminescent paint of this second example may have a variety of different colors and the compositions of the luminescent paint differ depending on the desired color. Dyes may be added to the urethane based luminescent paint in order to establish a desired color other than white. A variety of different types of dyes may be used to obtain the desired color of the urethane based luminescent paint. The dyes identified below are for exemplary purposes and are not intended to be limiting upon the present invention.

This second exemplary urethane based luminescent paint may be applied to a large variety of objects. Exemplary applications in which this second luminescent paint may be particularly effective may include, for example, automobiles and other motorized vehicles, trailers and other non-motorized vehicles, heavy machinery, tool boxes, hard hats, bollards, construction objects such as road cones, barrels, barriers, etc.

The following exemplary colors and compositions are for illustrative purposes only and provide only some of the possible colors and compositions.

If a white urethane based luminescent paint is desired, the paint may include the following quantities of components: 86 liquid ounces of urethane base, 32 liquid ounces of anti-settling agent, 10 liquid ounces of flex agent, and 1 kilogram of MMSWW-4D luminescent substance. As indicated above, dye may not be added if white is the desired color of the luminescent paint.

If a blue urethane based luminescent paint is desired, the paint may include the following quantities of components: 80 liquid ounces of urethane base, 32 liquid ounces of anti-settling agent, 10 liquid ounces of flex agent, 6 liquid ounces of 03238 dye manufactured by SEM Products, and 1 kilogram of MMHSB-8D luminescent substance.

If a light blue urethane based luminescent paint is desired, the paint may include the following quantities of components: 83 liquid ounces of urethane base, 32 liquid ounces of anti-settling agent, 10 liquid ounces of flex agent, 3 liquid ounces of 03238 dye manufactured by SEM Products, and 1 kilogram of MMHSB-9C luminescent substance.

An alternative light blue urethane based luminescent paint includes similar quantities of components as the previous light blue paint, however, this alternative light blue paint includes an alternative luminescent substance. More particularly, this alternative light blue paint includes 1 kilogram of MMHSB-9D luminescent substance.

If a green urethane based luminescent paint is desired, the paint may include the following quantities of components: 80 liquid ounces of urethane base, 32 liquid ounces of anti-settling agent, 10 liquid ounces of flex agent, 6 liquid ounces of 03248 dye manufactured by SEM Products, and 1 kilogram of MMHG-5B luminescent substance.

If a light green urethane based luminescent paint is desired, the paint may include the following quantities of components: 83 liquid ounces of urethane base, 32 liquid ounces of anti-settling agent, 10 liquid ounces of flex agent, 3 liquid ounces of 03248 dye manufactured by SEM Products, and 1 kilogram of MMHG-5B luminescent substance.

If a blue-green urethane based luminescent paint is desired, the paint may include the following quantities of components: 80 liquid ounces of urethane base, 32 liquid ounces of anti-settling agent, 10 liquid ounces of flex agent, 6 liquid ounces of 03238 dye manufactured by SEM Products, and 1 kilogram of MMHB-4B luminescent substance.

If a fluorescent yellow urethane based luminescent paint is desired, the paint may include the following quantities of components: 80 liquid ounces of urethane base, 32 liquid ounces of anti-settling agent, 10 liquid ounces of flex agent, 6 liquid ounces of 03278 dye manufactured by SEM Products, and 1 kilogram of MMHG-5B luminescent substance.

An alternative fluorescent yellow urethane based luminescent paint includes similar quantities of components as the previous fluorescent yellow paint, however, this alternative fluorescent yellow paint includes an alternative luminescent substance. More particularly, this alternative fluorescent yellow paint includes 1 kilogram of MMSWW-4D luminescent substance.

If a yellow urethane based luminescent paint is desired, the paint may include the following quantities of components: 80 liquid ounces of urethane base, 32 liquid ounces of anti-settling agent, 10 liquid ounces of flex agent, 6 liquid ounces of Planet Color PCLD5 dye manufactured by Sherwin-Williams Automotive Finishes Corp., and 1 kilogram of MMHG-5B luminescent substance.

An alternative yellow urethane based luminescent paint includes similar quantities of components as the previous yellow paint, however, this alternative yellow paint includes an alternative luminescent substance. More particularly, this alternative yellow paint includes 1 kilogram of MMSWW-4D luminescent substance.

If an orange urethane based luminescent paint is desired, the paint may include the following quantities of components: 80 liquid ounces of urethane base, 32 liquid ounces of anti-settling agent, 10 liquid ounces of flex agent, 6 liquid ounces of Planet Color PCLD5 dye manufactured by Sherwin-Williams Automotive Finishes Corp. of Cleveland, Ohio, 16 grams of Parasol Red EG Solvent Red 135 manufactured by Paramount Colors Inc. of Elk Grove Village, Ill. 60007, and 1 kilogram of MMHG-5B luminescent substance.

An alternative orange urethane based luminescent paint includes similar quantities of components as the previous orange paint, however, this alternative orange paint includes an alternative luminescent substance. More particularly, this alternative orange paint includes 1 kilogram of MMSWW-4D luminescent substance.

Another alternative orange urethane based luminescent paint includes similar quantities of components as the previous orange paints, however, this alternative orange paint includes a combination of luminescent substances to arrive at the 1 kilogram of total luminescent substance mass. More particularly, this alternative orange paint includes 0.75 kilograms of MMSWW-4D luminescent substance and 0.25 kilograms of WGR1-OW-12-18 Color Technology luminescent substance.

In further alternative orange urethane based luminescent paints, other types of dyes may be used to color the paint a desired color. Such dyes may include, for example, Parasol BK 196, Parasol GK 197, Parasol AB23, and Parasol A 24, all of which are manufactured by Paramount Colors Inc. of Elk Grove Village, Ill. 60007.

If a purple urethane based luminescent paint is desired, the paint may include the following quantities of components: 80 liquid ounces of urethane base, 32 liquid ounces of anti-settling agent, 10 liquid ounces of flex agent, 4 liquid ounces of 03238 dye manufactured by SEM Products, 2 liquid ounces of Planet Color PCLD8 dye manufactured by Sherwin-Williams Automotive Finishes Corp. of Cleveland, Ohio, 0.75 kilograms of MMHSB-9D luminescent substance, and 0.25 kilograms of WGR1-OW-12-18 Color Technology luminescent substance.

If a red urethane based luminescent paint is desired, the paint may include the following quantities of components: 86 liquid ounces of urethane base, 32 liquid ounces of anti-settling agent, 10 liquid ounces of flex agent, 16 grams of Parasol Red PH manufactured by Paramount Colors Inc. of Elk Grove Village, Ill. 60007, 0.30 kilograms of WGR1-OW-12-18 Color Technology luminescent substance, and 0.70 kilograms of MR-1 Yangzhou Huahan Plastic Colour Masterbatch luminescence substance.

In alternative red urethane based luminescent paints, other types of dyes may be used to color the paint a desired color. Such dyes may include, for example, Parasol BK 196, Parasol GK 197, Parasol AB23, and Parasol A 24, all of which are manufactured by Paramount Colors Inc. of Elk Grove Village, Ill. 60007.

Similar to the first exemplary urethane based paint described above, this second exemplary urethane based paint and all of its colors described above may, in some exemplary embodiments, include another substance or filler in order to provide additional beneficial characteristics to the second exemplary urethane based luminescent paint. The remarks above pertaining to the filler added to the first exemplary urethane based paint also apply to the second exemplary urethane based luminescent paint and, for the sake of brevity, will not be repeated here.

In the above exemplary colors of the second exemplary urethane based luminescent paint, the various elements of the paint comprise the following percentages of the total weight of the paint: urethane base comprises between about 43% and about 53% of the total weight; anti-settling agent comprises between about 16% and about 20% of the total weight; flex agent comprises between about 5% and about 7% of the total weight; dye comprises between 0% and about 4% of the total weight; luminescent substance comprises between about 17% and about 23% of the total weight; and filler comprises between 0% and about 18% of the total weight. Alternatively, the various elements of the paint may comprise other percentages of the total weight of the urethane based luminescent paint. For example, the various elements may comprise the following percentages of the total weight of the paint: urethane base may comprise between about 24% and about 95% of the total weight; anti-settling agent may comprise between about 7% and about 35% of the total weight; flex agent may comprise between about 0.3% and about 12% of the total weight; dye may comprise between 0% and about 10% of the total weight; luminescent substance may comprise between about 10% and about 35% of the total weight; and filler may comprise between 0% and about 35% of the total weight.

With reference to FIG. 5, an exemplary method of making the second exemplary urethane based luminescent paint in illustrated and will be described herein. This is only one of many different methods of making the second exemplary paint and this example is not intended to be limiting. Many other methods of making the second exemplary urethane based luminescent paint are contemplated and are within the spirit and scope of the present invention.

The first step in this exemplary method of making urethane based luminescent paint includes beginning with the full quantity of anti-settling agent (step 66). For this second exemplary urethane based luminescent paint, the full quantity of anti-settling agent is 32 liquid ounces. Next, dye is added to the anti-settling agent if it is desired for the luminescent paint to have a color other than white (step 68). The type of dye added to the anti-settling agent is dependent on the desired color of the luminescent paint. If dye is added, the dye and anti-settling agent are mixed until evenly blended. The components of this urethane based luminescent paint may be mixed in a variety of manners similar to those described above in connection with the first exemplary urethane based luminescent paint. After the dye is mixed with the anti-settling agent, a portion of the urethane base is added to the mixture of dye and anti-settling agent (step 70). For this second exemplary urethane based luminescent paint, the full quantity of urethane base varies depending on the desired color of the luminescent paint. The first portion added to the mixture may be any portion of the full quantity of the urethane base. In one example, 32 liquid ounces of the urethane base is added to the mixture of anti-settling agent and dye, and is mixed until evenly blended. After this mixture is evenly blended, the total quantity of luminescent substance is added to the mixture of anti-settling agent, dye, and a portion of the urethane base (step 72). The luminescent substance is mixed into the mixture until it is evenly blended. After the luminescent substance is mixed into the mixture, the total quantity of filler is added, if desired, and mixed until evenly blended (step 73). Next, the total quantity of flex agent is added to the mixture and mixed until evenly blended (step 74). Then, the remaining quantity of the urethane base is added to the mixture and mixed until evenly blended (step 76). Upon creating an evenly blended mixture including all the above components, the second exemplary urethane based luminescent paint is completed. The amount of time required to make this luminescent paint may vary. In some examples, the total amount of time required to make this luminescent paint may be about 30 minutes.

A third exemplary urethane based luminescent paint includes a urethane base, an anti-settling agent, and luminescent substance. In this example, the urethane base is made from scratch rather than utilizing a pre-mixed volume of urethane base which may be purchased over-the-counter. The components used in this example to comprise the urethane base include: Butyl acetate; a crosslinker such as Solucote XL-1 manufactured by Soluol, Inc. of Providence, R.I. 02915; a urethane resin such as Solucote 8980 manufactured by Soluol, Inc.; butyl alcohol; toluene; and xylene. The crosslinker assists with bonding the luminescent paint to objects and increases the speed at which the paint dries. Also in the present example, the anti-settling agent may be Y25X anti-settling product manufactured by Southern Clay Products, Inc. Alternatively, the anti-settling agent may be Y-20XP also manufactured by Southern Clay Products, Inc. Further in the present example, the luminescent substance may be strontium aluminate europium and may be one of a variety of products manufactured by MPK Co. Such examples of luminescent substance may be comprised of the following MPK Co. products: MMHSB-8D; MMHSB-9C; MMHG-5B; MMSWW-4D. Alternatively, the present example may include luminescent substance products manufactured by other entities such as WGR1-OW-12-18 manufactured by Color Technology of Howell, N.J. 07731 or MR-1 manufactured by Yangzhou Huahan Plastic Colour Masterbatch Co. Ltd. of Yangzhou City, Jiangsu Province, China.

The urethane based luminescent paint of this third example may have a variety of different colors and the compositions of the luminescent paint differ depending on the desired color. Dyes may be added to the urethane based luminescent paint in order to establish a desired color other than white. A variety of different types of dyes may be used to obtain the desired color of the urethane based luminescent paint. The dyes identified below are for exemplary purposes and are not intended to be limiting upon the present invention.

This third exemplary urethane based luminescent paint may be applied to a large variety of objects. Exemplary applications in which this third luminescent paint may be particularly effective may include, for example, floors, floor boards, light fixtures, walls, stairs, handrails, parking lot indicia, roadway indicia, airport runway indicia, bollards, construction objects such as road cones, barrels, barriers, etc.

The following exemplary colors and compositions are for illustrative purposes only and provide only some of the possible colors and compositions.

If a white urethane based luminescent paint is desired, the paint may include the following quantities of components: 32 liquid ounces of anti-settling agent, 10 liquid ounces of a crosslinker, 32 liquid ounces of Solucote 8980 urethane resin, 22 liquid ounces of butyl acetate, 13 liquid ounces of butyl alcohol, 12 liquid ounces of toluene, 9 liquid ounces of xylene, and 1 kilogram of MMSWW-4D luminescent substance. As indicated above, dye may not be added if white is the desired color of the luminescent paint.

If a blue urethane based luminescent paint is desired, the paint may include the following quantities of components: 32 liquid ounces of anti-settling agent, 10 liquid ounces of a crosslinker, 30 liquid ounces of Solucote 8980 urethane resin, 20 liquid ounces of butyl acetate, 12 liquid ounces of butyl alcohol, 10 liquid ounces of toluene, 8 liquid ounces of xylene, 6 liquid ounces of 03238 dye manufactured by SEM Products, and 1 kilogram of MMHSB-8D luminescent substance.

If a light blue urethane based luminescent paint is desired, the paint may include the following quantities of components: 32 liquid ounces of anti-settling agent, 10 liquid ounces of a crosslinker, 32 liquid ounces of Solucote 8980 urethane resin, 21 liquid ounces of butyl acetate, 12 liquid ounces of butyl alcohol, 10 liquid ounces of toluene, 8 liquid ounces of xylene, 3 liquid ounces of 03238 dye manufactured by SEM Products, and 1 kilogram of MMHSB-9C luminescent substance.

An alternative light blue urethane based luminescent paint includes similar quantities of components as the previous light blue paint, however, this alternative light blue paint includes an alternative luminescent substance. More particularly, this alternative light blue paint includes 1 kilogram of MMHSB-9D luminescent substance.

If a green urethane based luminescent paint is desired, the paint may include the following quantities of components: 32 liquid ounces of anti-settling agent, 10 liquid ounces of a crosslinker, 30 liquid ounces of Solucote 8980 urethane resin, 20 liquid ounces of butyl acetate, 12 liquid ounces of butyl alcohol, 10 liquid ounces of toluene, 8 liquid ounces of xylene, 6 liquid ounces of 03248 dye manufactured by SEM Products, and 1 kilogram of MMHG-5B luminescent substance.

If a light green urethane based luminescent paint is desired, the paint may include the following quantities of components: 32 liquid ounces of anti-settling agent, 10 liquid ounces of a crosslinker, 32 liquid ounces of Solucote 8980 urethane resin, 21 liquid ounces of butyl acetate, 12 liquid ounces of butyl alcohol, 10 liquid ounces of toluene, 8 liquid ounces of xylene, 3 liquid ounces of 03248 dye manufactured by SEM Products, and 1 kilogram of MMHG-5B luminescent substance.

If a blue-green urethane based luminescent paint is desired, the paint may include the following quantities of components: 32 liquid ounces of anti-settling agent, 10 liquid ounces of a crosslinker, 30 liquid ounces of Solucote 8980 urethane resin, 20 liquid ounces of butyl acetate, 12 liquid ounces of butyl alcohol, 10 liquid ounces of toluene, 8 liquid ounces of xylene, 6 liquid ounces of 03238 dye manufactured by SEM Products, and 1 kilogram of MMHB-4B luminescent substance.

If a fluorescent yellow urethane based luminescent paint is desired, the paint may include the following quantities of components: 32 liquid ounces of anti-settling agent, 10 liquid ounces of a crosslinker, 30 liquid ounces of Solucote 8980 urethane resin, 20 liquid ounces of butyl acetate, 12 liquid ounces of butyl alcohol, 10 liquid ounces of toluene, 8 liquid ounces of xylene, 6 liquid ounces of 03278 dye manufactured by SEM Products, and 1 kilogram of MMHG-5B luminescent substance.

If a yellow urethane based luminescent paint is desired, the paint may include the following quantities of components: 32 liquid ounces of anti-settling agent, 10 liquid ounces of a crosslinker, 30 liquid ounces of Solucote 8980 urethane resin, 20 liquid ounces of butyl acetate, 12 liquid ounces of butyl alcohol, 10 liquid ounces of toluene, 8 liquid ounces of xylene, 6 liquid ounces of Planet Color PCLD5 dye manufactured by Sherwin-Williams Automotive Finishes Corp., and 1 kilogram of MMHG-5B luminescent substance.

If an orange urethane based luminescent paint is desired, the paint may include the following quantities of components: 32 liquid ounces of anti-settling agent, 10 liquid ounces of a crosslinker, 30 liquid ounces of Solucote 8980 urethane resin, 20 liquid ounces of butyl acetate, 12 liquid ounces of butyl alcohol, 10 liquid ounces of toluene, 8 liquid ounces of xylene, 6 liquid ounces of Planet Color PCLD5 dye manufactured by Sherwin-Williams Automotive Finishes Corp., 16 grams of Parasol Red EG Solvent Red 135 manufactured by Paramount Colors Inc. of Elk Grove Village, Ill. 60007, and 1 kilogram of MMHG-5B luminescent substance.

In alternative orange urethane based luminescent paints, other types of dyes may be used to color the paint a desired color. Such dyes may include, for example, Parasol BK 196, Parasol GK 197, Parasol AB23, and Parasol A 24, all of which are manufactured by Paramount Colors Inc. of Elk Grove Village, Ill. 60007.

If a red urethane based luminescent paint is desired, the paint may include the following quantities of components: 32 liquid ounces of anti-settling agent, 10 liquid ounces of a crosslinker, 36 liquid ounces of Solucote 8980 urethane resin, 20 liquid ounces of butyl acetate, 12 liquid ounces of butyl alcohol, 10 liquid ounces of toluene, 8 liquid ounces of xylene, 16 grams of Parasol Red PH manufactured by Paramount Colors Inc. of Elk Grove Village, Ill. 60007, 0.30 kilograms of WGR1-OW-12-18 Color Technology luminescent substance, and 0.70 kilograms of MR-1 Yangzhou Huahan Plastic Colour Masterbatch luminescence substance.

In alternative red urethane based luminescent paints, other types of dyes may be used to color the paint a desired color. Such dyes may include, for example, Parasol BK 196, Parasol GK 197, Parasol AB23, and Parasol A 24, all of which are manufactured by Paramount Colors Inc. of Elk Grove Village, Ill. 60007.

Similar to the first exemplary urethane based paint described above, this third exemplary urethane based paint and all of its colors described above may, in some exemplary embodiments, include another substance or filler in order to provide additional beneficial characteristics to the third exemplary urethane based luminescent paint. The remarks above pertaining to the filler added to the first exemplary urethane based paint also apply to the third exemplary urethane based luminescent paint and, for the sake of brevity, will not be repeated here.

In the above exemplary colors of the third exemplary urethane based luminescent paint, the various components of the paint comprise the following percentages of the total weight of the paint: urethane base comprises between about 48% and about 63% of the total weight; anti-settling agent comprises between about 15% and about 20% of the total weight; dye comprises between 0% and about 4% of the total weight; luminescent substance comprises between about 17% and about 23% of the total weight; and filler may comprise between 0% and about 18% of the total weight. Alternatively, the various elements of the paint may comprise other percentages of the total weight of the urethane based luminescent paint. For example, the various elements may comprise the following percentages of the total weight of the paint: urethane base may comprise between about 24% and about 95% of the total weight; anti-settling agent may comprise between about 10% and about 26% of the total weight; dye may comprise between 0% and about 10% of the total weight; luminescent substance may comprise between about 10% and about 35% of the total weight; and filler may comprise between 0% and about 35% of the total weight. In the third exemplary embodiment, the urethane base is made of a variety of exemplary elements, each of which comprises a percentage of the total weight of the urethane based luminescent paint. For example, the elements of the urethane base and their percentages of the total weight of the paint are as follows: butyl acetate comprises between about 10% and about 14% of the total weight; crosslinker comprises between about 4% and about 7% of the total weight; urethane resin comprises between about 15% and about 22% of the total weight; butyl alcohol comprises between about 6% and about 8% of the total weight; toluene comprises between about 5% and about 8% of the total weight; and xylene comprises between about 4% and about 6% of the total weight.

Another manner in which to consider the third exemplary urethane based paint is by the elements that comprise solvents and the elements that comprise non-solvents. In this third example, the solvents may comprise butyl acetate, butyl alcohol, toluene, and xylene, and the non-solvents may comprise the anti-settling agent, urethane resin, crosslinker, dye, luminescent substance, and filler. The solvents and non-solvents used in this exemplary urethane based paint are exemplary and a variety of other solvents and non-solvents may be used with the urethane based luminescent paint and still be within the spirit and scope of the invention. In this third exemplary urethane based luminescent paint, the solvents in combination comprise between about 25% and about 35% of the total weight, and the non-solvents comprise between about 65% and about 75% of the total weight. Alternatively, the solvents and non-solvents may comprise other percentages of the total weight of the urethane based luminescent paint. For example, the solvents in combination may comprise between about 20% and about 70% of the total weight of the paint. Also, for example, the non-solvents in combination may comprise between about 30% and about 85% of the total weight of the paint. Additionally, the non-solvents may be parsed into individual elements and may include the following percentages of the total weight of the paint: anti-settling agent may comprise between about 10% and about 27% of the total weight; urethane resin may comprise between about 10% and about 26% of the total weight; crosslinker may comprise between about 0.5% and about 12% of the total weight; dye may comprise between about 0% and about 10% of the total weight; luminescent substance may comprise between about 10% and about 35% of the total weight; and filler may comprise between 0% and about 35% of the total weight.

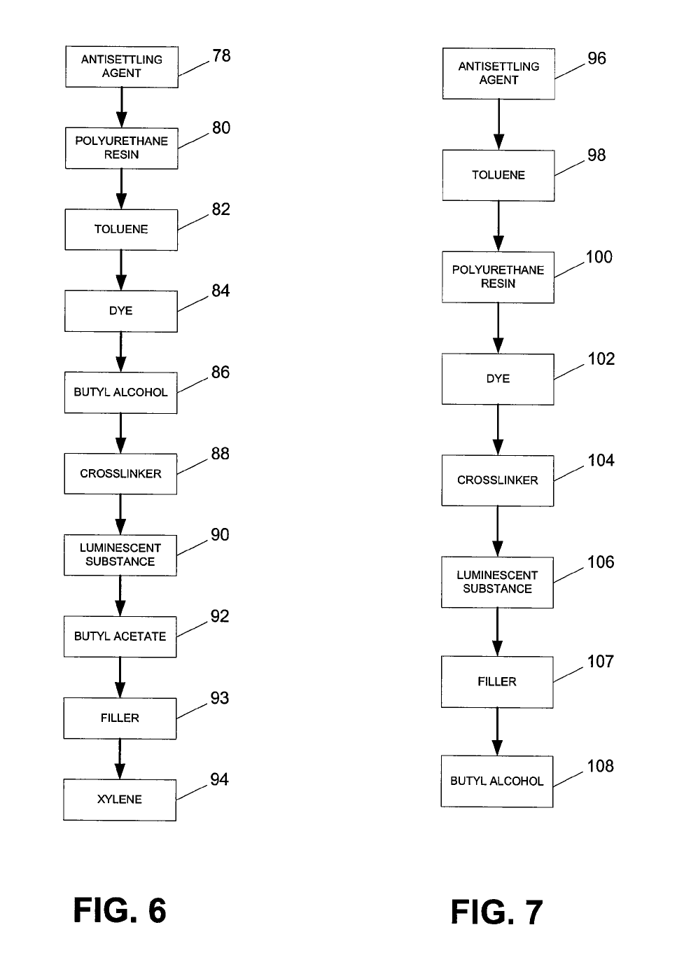

With reference to FIG. 6, an exemplary method of making the third exemplary urethane based luminescent paint in illustrated and will be described herein. This is only one of many different methods of making the third exemplary paint and this example is not intended to be limiting. Many other methods of making the third exemplary urethane based luminescent paint are contemplated and are within the spirit and scope of the present invention.

The first step in this exemplary method of making urethane based luminescent paint includes beginning with the full quantity of anti-settling agent (step 78). For this third exemplary urethane based luminescent paint, the full quantity of anti-settling agent is 32 liquid ounces. Next, the total quantity of urethane resin is added to the anti-settling agent and mixed until evenly blended (step 80). For this third exemplary urethane based luminescent paint, the full quantity of urethane resin varies depending on the desired color of the luminescent paint. The components of this urethane based luminescent paint may be mixed in a variety of manners similar to those described above in connection with the first exemplary urethane based luminescent paint. After this mixture is evenly blended, the total quantity of toluene is added and mixed until evenly blended (step 82). Next, the total quantity of dye is added to the mixture if it is desired for the luminescent paint to have a color (step 84). The type of dye added to the mixture is dependent upon the desired color of the luminescent paint. After the dye is evenly blended with the mixture, the total quantity of butyl alcohol is added to the mixture and mixed until blended evenly (step 86). Next, the total quantity of crosslinker is added to the mixture and mixed until evenly blended (step 88). After the mixture is evenly blended, the total quantity of luminescent substance is added to the mixture and mixed until evenly blended (step 90). Then, the total quantity of butyl acetate is added to the mixture and mixed until it is evenly blended (step 92). Next, if desired, the full quantity of filler is added and mixed until evenly blended (step 93). Finally, the total quantity of xylene is added to the mixture and mixed until it is evenly blended (step 94). Upon creating an evenly blended mixture including all the above components, the third exemplary urethane based luminescent paint is completed. The amount of time required to make this luminescent paint may vary. In some examples, the total amount of time required to make this luminescent paint may be about 30 minutes.

A fourth exemplary urethane based luminescent paint includes a urethane base, an anti-settling agent, and luminescent substance. In this example, as was the case in the third example, the urethane base is made from scratch rather than utilizing a pre-mixed volume of urethane base which may be purchased over-the-counter. The elements used in this example to comprise the urethane base include: A crosslinker such as Solucote XL-1 manufactured by Soluol, Inc.; a urethane resin such as Solucote 6010 manufactured by Soluol, Inc.; butyl alcohol; and toluene. Also in the present example, the anti-settling agent may be Y25X anti-settling product manufactured by Southern Clay Products, Inc. Alternatively, the anti-settling agent may be Y-20XP also manufactured by Southern Clay Products, Inc. Further in the present example, the luminescent substance may be strontium aluminate europium and may be one of a variety of products manufactured by MPK Co. Such examples of luminescent substance may be comprised of the following MPK Co. products: MMHSB-8D; MMHSB-9D; MMHSB-9C; MMHG-5B; MMSWW-4D. Alternatively, the present example may include luminescent substance products manufactured by other entities such as WGR1-OW-12-18 manufactured by Color Technology of Howell, N.J. 07731 or MR-1 manufactured by Yangzhou Huahan Plastic Colour Masterbatch Co. Ltd. of Yangzhou City, Jiangsu Province, China.

The urethane based luminescent paint of this fourth example may have a variety of different colors and the compositions of the luminescent paint will differ depending on the desired color. Dyes may be added to the urethane based luminescent paint in order to establish a desired color other than white. A variety of different types of dyes may be used to obtain the desired color of the urethane based luminescent paint. The dyes identified below are for exemplary purposes and are not intended to be limiting upon the present invention.

This fourth exemplary urethane based luminescent paint may be applied to a large variety of objects. Exemplary applications in which this fourth urethane based luminescent paint may be particularly effective may include, for example, floors, floor boards, light fixtures, walls, stairs, handrails, parking lot indicia, roadway indicia, airport runway indicia, bollards, construction objects such as road cones, barrels, barriers, etc.

The following exemplary colors and compositions are for illustrative purposes only and provide only some of the possible colors and compositions.

If a white urethane based luminescent paint is desired, the paint may include the following quantities of components: 32 liquid ounces of anti-settling agent, 12 liquid ounces of a crosslinker, 38 liquid ounces of Solucote 6010 urethane resin, 24 liquid ounces of butyl alcohol, 22 liquid ounces of toluene, and 1 kilogram of MMSWW-4D luminescent substance. As indicated above, dye may not be added if white is the desired color of the luminescent paint.

If a blue urethane based luminescent paint is desired, the paint may include the following quantities of components: 32 liquid ounces of anti-settling agent, 10 liquid ounces of a crosslinker, 38 liquid ounces of Solucote 6010 urethane resin, 22 liquid ounces of butyl alcohol, 20 liquid ounces of toluene, 6 liquid ounces of 03238 dye manufactured by SEM Products, and 1 kilogram of MMHSB-8D luminescent substance.

If a light blue urethane based luminescent paint is desired, the paint may include the following quantities of components: 32 liquid ounces of anti-settling agent, 11 liquid ounces of a crosslinker, 38 liquid ounces of Solucote 6010 urethane resin, 23 liquid ounces of butyl alcohol, 21 liquid ounces of toluene, 3 liquid ounces of 03238 dye manufactured by SEM Products, and 1 kilogram of MMHSB-9C luminescent substance.

An alternative light blue urethane based luminescent paint includes similar quantities of components as the previous light blue paint, however, this alternative light blue paint includes an alternative luminescent substance. More particularly, this alternative light blue paint includes 1 kilogram of MMHSB-9D luminescent substance.

If a green urethane based luminescent paint is desired, the paint may include the following quantities of components: 32 liquid ounces of anti-settling agent, 10 liquid ounces of a crosslinker, 38 liquid ounces of Solucote 6010 urethane resin, 22 liquid ounces of butyl alcohol, 20 liquid ounces of toluene, 6 liquid ounces of 03248 dye manufactured by SEM Products, and 1 kilogram of MMHG-5B luminescent substance.

If a light green urethane based luminescent paint is desired, the paint may include the following quantities of components: 32 liquid ounces of anti-settling agent, 11 liquid ounces of a crosslinker, 38 liquid ounces of Solucote 6010 urethane resin, 23 liquid ounces of butyl alcohol, 21 liquid ounces of toluene, 3 liquid ounces of 03248 dye manufactured by SEM Products, and 1 kilogram of MMHG-5B luminescent substance.

If a blue-green urethane based luminescent paint is desired, the paint may include the following quantities of components: 32 liquid ounces of anti-settling agent, 10 liquid ounces of a crosslinker, 38 liquid ounces of Solucote 6010 urethane resin, 22 liquid ounces of butyl alcohol, 20 liquid ounces of toluene, 6 liquid ounces of 03238 dye manufactured by SEM Products, and 1 kilogram of MMHSB-58D luminescent substance.

If a fluorescent yellow urethane based luminescent paint is desired, the paint may include the following quantities of components: 32 liquid ounces of anti-settling agent, 10 liquid ounces of a crosslinker, 38 liquid ounces of Solucote 6010 urethane resin, 22 liquid ounces of butyl alcohol, 20 liquid ounces of toluene, 6 liquid ounces of 03278 dye manufactured by SEM Products, and 1 kilogram of MMHG-5B luminescent substance.

If a yellow urethane based luminescent paint is desired, the paint may include the following quantities of components: 32 liquid ounces of anti-settling agent, 10 liquid ounces of a crosslinker, 38 liquid ounces of Solucote 6010 urethane resin, 22 liquid ounces of butyl alcohol, 20 liquid ounces of toluene, 6 liquid ounces of Planet Color PCLD5 dye manufactured by Sherwin-Williams Automotive Finishes Corp., and 1 kilogram of MMHG-5B luminescent substance.

If an orange urethane based luminescent paint is desired, the paint may include the following quantities of components: 32 liquid ounces of anti-settling agent, 10 liquid ounces of a crosslinker, 38 liquid ounces of Solucote 6010 urethane resin, 22 liquid ounces of butyl alcohol, 20 liquid ounces of toluene, 6 liquid ounces of Planet Color PCLD5 dye manufactured by Sherwin-Williams Automotive Finishes Corp., 16 grams of Parasol Red EG Solvent Red 135 manufactured by Paramount Colors Inc. of Elk Grove Village, Ill. 60007, and 1 kilogram of MMHG-5B luminescent substance.

In alternative orange urethane based luminescent paints, other types of dyes may be used to color the paint a desired color. Such dyes may include, for example, Parasol BK 196, Parasol GK 197, Parasol AB23, and Parasol A 24, all of which are manufactured by Paramount Colors Inc. of Elk Grove Village, Ill. 60007.

If a red urethane based luminescent paint is desired, the paint may include the following quantities of components: 32 liquid ounces of anti-settling agent, 10 liquid ounces of a crosslinker, 44 liquid ounces of Solucote 6010 urethane resin, 22 liquid ounces of butyl alcohol, 20 liquid ounces of toluene, 16 grams of Parasol Red PH manufactured by Paramount Colors Inc. of Elk Grove Village, Ill. 60007, 0.30 kilograms of WGR1-OW-12-18 Color Technology luminescent substance, and 0.70 kilograms of MR-1 Yangzhou Huahan Plastic Colour Masterbatch luminescence substance.

In alternative red urethane based luminescent paints, other types of dyes may be used to color the paint a desired color. Such dyes may include, for example, Parasol BK 196, Parasol GK 197, Parasol AB23, and Parasol A 24, all of which are manufactured by Paramount Colors Inc. of Elk Grove Village, Ill. 60007.

Similar to the first exemplary urethane based paint described above, this fourth exemplary urethane based paint and all of its colors described above may, in some exemplary embodiments, include another substance or filler in order to provide additional beneficial characteristics to the fourth exemplary urethane based luminescent paint. The remarks above pertaining to the filler added to the first exemplary urethane based paint also apply to the fourth exemplary urethane based luminescent paint and, for the sake of brevity, will not be repeated here.

In the above exemplary colors of the fourth exemplary urethane based luminescent paint, the various elements of the paint comprise the following percentages of the total weight of the paint: urethane base comprises between about 48% and about 63% of the total weight; anti-settling agent comprises between about 16% and about 20% of the total weight; dye comprises between 0% and about 4% of the total weight; luminescent substance comprises between about 17% and about 23% of the total weight; and filler comprises between about 0% and about 18% of the total weight. Alternatively, the various elements of the paint may comprise other percentages of the total weight of the urethane based luminescent paint. For example, the various elements may comprise the following percentages of the total weight of the paint: urethane base may comprise between about 24% and about 95% of the total weight; anti-settling agent may comprise between about 10% and about 26% of the total weight; dye may comprise between 0% and about 10% of the total weight; luminescent substance may comprise between about 10% and about 35% of the total weight; and filler may comprise between 0% and about 35%. In the fourth exemplary embodiment, the urethane base is comprised of a variety of exemplary elements, each of which comprise a percentage of the total weight of the urethane based luminescent paint. For example, the elements of the urethane base and their percentages of the total weight of the paint are as follows: crosslinker comprises between about 5% and about 8% of the total weight; urethane resin comprises between about 19% and about 27% of the total weight; butyl alcohol comprises between about 12% and about 15% of the total weight; and toluene comprises between about 11% and about 14% of the total weight.

Another manner in which to consider the third exemplary urethane based paint is by the elements that comprise solvents and the elements that comprise non-solvents. In this fourth example, the solvents comprise butyl alcohol and toluene, and the non-solvents comprise the anti-settling agent, urethane resin, crosslinker, dye, luminescent substance, and filler. The solvents and non-solvents used in this exemplary urethane based paint are exemplary and a variety of other solvents and non-solvents may be used with the urethane based luminescent paint and still be within the spirit and scope of the invention. In this fourth exemplary urethane based luminescent paint, the solvents in combination comprise between about 23% and about 30% of the total weight, and the non-solvents comprise between about 70% and about 77% of the total weight. Alternatively, the solvents and non-solvents may comprise other percentages of the total weight of the urethane based luminescent paint. For example, the solvents in combination may comprise between about 15% and about 70% of the total weight of the paint. Also, for example, the non-solvents in combination may comprise between about 30% and about 85% of the total weight of the paint. Additionally, the non-solvents may be parsed into individual elements and may include the following percentages of the total weight of the paint: anti-settling agent may comprise between about 12% and about 27% of the total weight; urethane resin may comprise between about 15% and about 32% of the total weight; crosslinker may comprise between about 0.5% and about 15% of the total weight; dye may comprise between about 0% and about 10% of the total weight; luminescent substance may comprise between about 10% and about 35% of the total weight; and filler may comprise between 0% and about 35% of the total weight.

With reference to FIG. 7, an exemplary method of making the fourth exemplary urethane based luminescent paint in illustrated and will be described herein. This is only one of many different methods of making the fourth exemplary paint and this example is not intended to be limiting. Many other methods of making the fourth exemplary urethane based luminescent paint are contemplated and are within the spirit and scope of the present invention.

The first step in this exemplary method of making urethane based luminescent paint includes beginning with the full quantity of anti-settling agent (step 96). For this fourth exemplary urethane based luminescent paint, the full quantity of anti-settling agent is 32 liquid ounces. Next, the total quantity of toluene is added to the anti-settling agent and mixed until evenly blended (step 98). The components of this urethane based luminescent paint may be mixed in a variety of manners similar to those described above in connection with the first exemplary urethane based luminescent paint. After the anti-settling agent and toluene are evenly blended, the total quantity of urethane resin is added to the mixture and mixed until evenly blended (step 100). Next, dye is added to the mixture if it is desired for the luminescent paint to have a color (step 102). The type of dye added to the mixture is dependent upon the desired color of the luminescent paint. After the dye is evenly blended with the mixture, the total quantity of crosslinker is added to the mixture and mixed until evenly blended (step 104). Next, the total quantity of luminescent substance is added to the mixture and mixed until evenly blended (step 106). Then, if desired, the total quantity of filler is added to the mixture and mixed until evenly blended (step 107). Finally, the total quantity of butyl alcohol is added to the mixture and mixed until evenly blended (step 108). Upon creating an evenly blended mixture including all the above components, the fourth exemplary urethane based luminescent paint is completed. The amount of time required to make this luminescent paint may vary. In some examples, the total amount of time required to make this luminescent paint may be about 30 minutes.

A fifth exemplary urethane based luminescent paint includes a urethane base, an anti-settling agent, and luminescent substance. In this example, the urethane base is made from scratch rather than utilizing a pre-mixed volume of urethane base which may be purchased over-the-counter. The components used in this example to comprise the urethane base include: Butyl acetate; methyl ethyl ketone; a crosslinker such as Solucote XL-1 manufactured by Soluol, Inc. of Providence, R.I. 02915 or CX-100 manufactured by DSM NeoResins of Wilmington, Mass. 01887; a urethane resin such as Solucote 8980 manufactured by Soluol, Inc.; one or more wetting agents or dispersants such as OT75pg surfactant manufactured by Cytec Industries of Willow Island, W.V. 26134 or 152k sperse dispersant manufactured by King Industries of Norwalk, Conn. 06852; butyl alcohol; toluene; and xylene. Also in the present example, the anti-settling agent may be Y25X anti-settling product manufactured by Southern Clay Products, Inc. Alternatively, the anti-settling agent may be Y-20XP also manufactured by Southern Clay Products, Inc. or Disparlon 4200-20 manufactured by King Industries of Norwalk, Conn. 06852. Further in the present example, the luminescent substance may be strontium aluminate europium and may be one of a variety of products manufactured by MPK Co. Such examples of luminescent substance may be comprised of the following MPK Co. products: MMHSB-8D; MMHSB-9C; MMHG-5B; MMSWW-4D. Alternatively, the present example may include luminescent substance products manufactured by other entities such as WGR1-OW-12-18 manufactured by Color Technology of Howell, N.J. 07731 or MR-1 manufactured by Yangzhou Huahan Plastic Colour Masterbatch Co. Ltd. of Yangzhou City, Jiangsu Province, China.

The urethane based luminescent paint of this fifth example may have a variety of different colors and the compositions of the luminescent paint differ depending on the desired color. Dyes may be added to the urethane based luminescent paint in order to establish a desired color other than white. A variety of different types of dyes may be used to obtain the desired color of the urethane based luminescent paint. The dyes identified below are for exemplary purposes and are not intended to be limiting upon the present invention.

This fifth exemplary urethane based luminescent paint may be applied to a large variety of objects. Exemplary applications in which this fifth luminescent paint may be particularly effective may include, for example, floors, floor boards, light fixtures, walls, stairs, handrails, parking lot indicia, roadway indicia, airport runway indicia, bollards, construction objects such as road cones, barrels, barriers, etc.

The following exemplary colors and compositions are for illustrative purposes only and provide only some of the possible colors and compositions.

If a fluorescent yellow urethane based luminescent paint is desired, the paint may include the following quantities of components: 20 liquid ounces of anti-settling agent, 5 liquid ounces of a crosslinker, 42 liquid ounces of Solucote 8980 urethane resin, 5 liquid ounces of OT75pg surfactant, 5 liquid ounces of 152k sperse dispersant, 15 liquid ounces of butyl acetate, 15 liquid ounces of methyl ethyl ketone, 5 liquid ounces of butyl alcohol, 5 liquid ounces of toluene, 5 liquid ounces of xylene, 6 liquid ounces of 03278 dye manufactured by SEM Products, and 1 kilogram of MMSWW-4D luminescent substance.

If a yellow urethane based luminescent paint is desired, the paint may include the following quantities of components: 20 liquid ounces of anti-settling agent, 5 liquid ounces of a crosslinker, 42 liquid ounces of Solucote 8980 urethane resin, 5 liquid ounces of OT75pg surfactant, 5 liquid ounces of 152k sperse dispersant, 15 liquid ounces of butyl acetate, 15 liquid ounces of methyl ethyl ketone, 5 liquid ounces of butyl alcohol, 5 liquid ounces of toluene, 5 liquid ounces of xylene, 6 liquid ounces of Planet Color PCLD5 dye manufactured by Sherwin-Williams Automotive Finishes Corp., and 1 kilogram of MMSWW-4D luminescent substance.

If an orange urethane based luminescent paint is desired, the paint may include the following quantities of components: 20 liquid ounces of anti-settling agent, 5 liquid ounces of a crosslinker, 42 liquid ounces of Solucote 8980 urethane resin, 5 liquid ounces of OT75pg surfactant, 5 liquid ounces of 152k sperse dispersant, 15 liquid ounces of butyl acetate, 15 liquid ounces of methyl ethyl ketone, 5 liquid ounces of butyl alcohol, 5 liquid ounces of toluene, 5 liquid ounces of xylene, 6 liquid ounces of Planet Color PCLD5 dye manufactured by Sherwin-Williams Automotive Finishes Corp., 16 grams of Parasol Red EG Solvent Red 135 manufactured by Paramount Colors Inc. of Elk Grove Village, Ill. 60007, and 1 kilogram of MMSWW-4D luminescent substance.

An alternative orange urethane based luminescent paint includes similar quantities of components as the previous orange paint, however, this alternative orange paint includes a combination of luminescent substances to arrive at the 1 kilogram of total luminescent substance mass. More particularly, this alternative orange paint includes 0.75 kilograms of MMSWW-4D luminescent substance and 0.25 kilograms of WGR1-OW-12-18 luminescent substance.

In other alternative orange urethane based luminescent paints, other types of dyes may be used to color the paint a desired color. Such dyes may include, for example, Parasol BK 196, Parasol GK 197, Parasol AB23, and Parasol A 24, all of which are manufactured by Paramount Colors Inc. of Elk Grove Village, Ill. 60007.

If a purple urethane based luminescent paint is desired, the paint may include the following quantities of components: 20 liquid ounces of anti-settling agent, 5 liquid ounces of a crosslinker, 42 liquid ounces of Solucote 8980 urethane resin, 5 liquid ounces of OT75pg surfactant, 5 liquid ounces of 152k sperse dispersant, 15 liquid ounces of butyl acetate, 15 liquid ounces of methyl ethyl ketone, 5 liquid ounces of butyl alcohol, 5 liquid ounces of toluene, 5 liquid ounces of xylene, 4 liquid ounces of 03238 dye manufactured by SEM Products, 2 liquid ounces of Planet Color PCLD8 dye manufactured by Sherwin-Williams Automotive Finishes Corp., 0.75 kilograms of MMHSB-9D luminescent substance, and 0.25 kilograms of WGR1-OW-12-18 luminescent substance.

If a red urethane based luminescent paint is desired, the paint may include the following quantities of components: 20 liquid ounces of anti-settling agent, 5 liquid ounces of a crosslinker, 42 liquid ounces of Solucote 8980 urethane resin, 5 liquid ounces of OT75pg surfactant, 5 liquid ounces of 152k sperse dispersant, 15 liquid ounces of butyl acetate, 15 liquid ounces of methyl ethyl ketone, 5 liquid ounces of butyl alcohol, 5 liquid ounces of toluene, 5 liquid ounces of xylene, 16 grams of Parasol Red PH manufactured by Paramount Colors Inc. of Elk Grove Village, Ill. 60007, 0.30 kilograms of WGR1-OW-12-18 Color Technology luminescent substance, and 0.70 kilograms of MR-1 Yangzhou Huahan Plastic Colour Masterbatch luminescence substance.

In alternative red urethane based luminescent paints, other types of dyes may be used to color the paint a desired color. Such dyes may include, for example, Parasol BK 196, Parasol GK 197, Parasol AB23, and Parasol A 24, all of which are manufactured by Paramount Colors Inc. of Elk Grove Village, Ill. 60007.

Similar to the first exemplary urethane based paint described above, this fifth exemplary urethane based paint and all of its colors described above may, in some exemplary embodiments, include another substance or filler in order to provide additional beneficial characteristics to the fifth exemplary urethane based luminescent paint. The remarks above pertaining to the filler added to the first exemplary urethane based paint also apply to the fifth exemplary urethane based luminescent paint and, for the sake of brevity, will not be repeated here.

In the above exemplary colors of the fifth exemplary urethane based luminescent paint, the various elements of the paint comprise the following percentages of the total weight of the paint: urethane base comprises between about 51% and about 75% of the total weight; anti-settling agent comprises between about 10% and about 13% of the total weight; dye comprises between 3% and about 4% of the total weight; luminescent substance comprises between about 17% and about 23% of the total weight; and filler comprises between 0% and about 18% of the total weight. Alternatively, the various components of the paint may comprise other percentages of the total weight of the urethane based luminescent paint. For example, the various elements may comprise the following percentages of the total weight of the paint: urethane base may comprise between about 24% and about 95% of the total weight; anti-settling agent may comprise between about 7% and about 17% of the total weight; dye may comprise between 0% and about 10% of the total weight; luminescent substance may comprise between about 10% and about 35% of the total weight; and filler may comprise between 0% and about 35%. In the fifth exemplary embodiment, the urethane base is comprised of a variety of exemplary elements, each of which comprise a percentage of the total weight of the urethane based luminescent paint. For example, the elements of the urethane base and their percentages of the total weight of the paint are as follows: crosslinker comprises between about 2% and about 4% of the total weight; urethane resin comprises between about 21% and about 26% of the total weight; surfactant comprises between about 2% and about 4%; dispersant comprises between about 2% and about 4%; butyl acetate comprises between about 7% and about 10%; methyl ethyl ketone comprises between about 7% and about 10%; butyl alcohol comprises between about 2% and about 4% of the total weight; toluene comprises between about 2% and about 4% of the total weight; and xylene comprises between about 2% and about 4% of the total weight.

Another manner in which to consider the fifth exemplary urethane based paint is by the elements that comprise solvents and the elements that comprise non-solvents. In this fifth example, the solvents comprise surfactant, dispersant, butyl acetate, methyl ethyl ketone, butyl alcohol, toluene, and xylene, and the non-solvents comprise the anti-settling agent, urethane resin, crosslinker, dye, luminescent substance, and filler. The solvents and non-solvents used in this exemplary urethane based paint are exemplary and a variety of other solvents and non-solvents may be used with the urethane based luminescent paint and still be within the spirit and scope of the invention. In this fifth exemplary urethane based luminescent paint, the solvents in combination comprise between about 27% and about 34% of the total weight and the non-solvents comprise between about 66% and about 73% of the total weight. Alternatively, the solvents and non-solvents may comprise other percentages of the total weight of the urethane based luminescent paint. For example, the solvents in combination may comprise between about 20% and about 70% of the total weight of the paint. Also, for example, the non-solvents in combination may comprise between about 30% and about 80% of the total weight of the paint. Additionally, the non-solvents may be parsed into individual elements and may include the following percentages of the total weight: anti-settling agent may comprise between about 7% and about 17% of the total weight; urethane resin may comprise between about 15% and about 37% of the total weight; crosslinker may comprise between about 0.3% and about 6% of the total weight; dye may comprise between about 0% and about 10% of the total weight; luminescent substance may comprise between about 10% and about 35% of the total weight; and filler may comprise between 0% and about 35%.

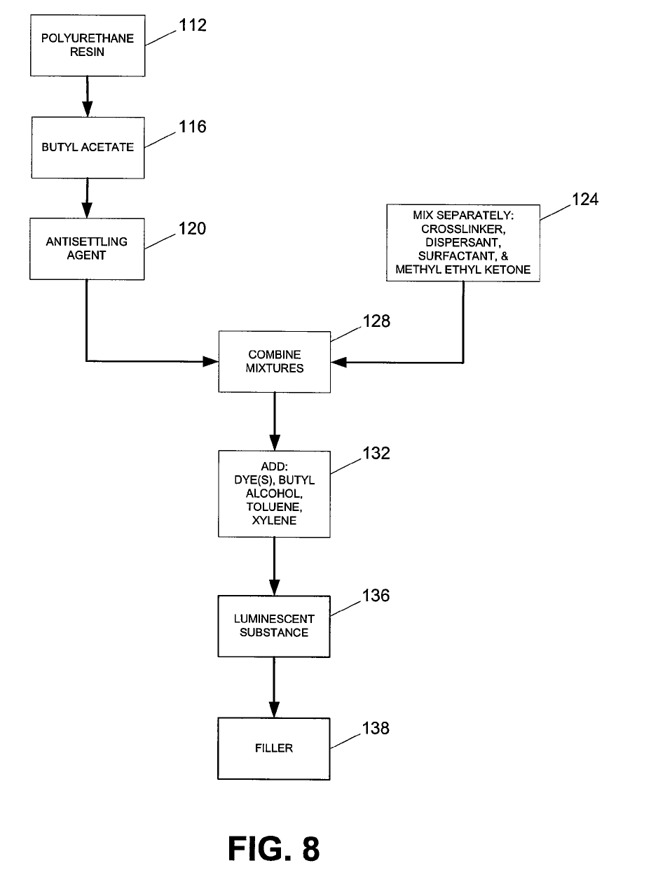

With reference to FIG. 8, an exemplary method of making the fifth exemplary urethane based luminescent paint in illustrated and will be described herein. This is only one of many different methods of making the fifth exemplary paint and this example is not intended to be limiting. Many other methods of making the fifth exemplary urethane based luminescent paint are contemplated and are within the spirit and scope of the present invention.

The first step in this exemplary method of making urethane based luminescent paint includes beginning with the full quantity of urethane resin (step 112) and placing the urethane resin in a first container. For this fifth exemplary urethane based luminescent paint, the full quantity of urethane resin is 42 liquid ounces. Next, the total quantity of butyl acetate is added to the urethane resin in the first container and mixed until evenly blended (step 116). For this fifth exemplary urethane based luminescent paint, the full quantity of butyl acetate is 15 liquid ounces. The components of this urethane based luminescent paint may be mixed in a variety of manners similar to those described above in connection with the first exemplary urethane based luminescent paint. After this mixture is evenly blended, the total quantity of anti-settling agent is added to the first container and mixed until evenly blended (step 120). For this fifth exemplary urethane based luminescent paint, the full quantity of anti-settling agent is 20 liquid ounces. In a second container different than the first container, full quantities of the crosslinker, dispersant, surfactant, and methyl ethyl ketone are mixed until evenly blended (step 124). Next, the mixture of urethane resin, butyl acetate, and anti-settling agent in the first container is combined with the mixture of crosslinker, dispersant, surfactant, and methyl ethyl ketone in the second container and mixed until evenly blended (step 128). After the two mixtures are blended evenly, the total quantities of dye, butyl alcohol, toluene, and xylene are added and mixed until evenly blended (step 132). Then, the total quantity of luminescent substance is added to the mixture and mixed until evenly blended (step 136). Finally, if desired, the total quantity of filler is added to the mixture and mixed until evenly blended (step 138). Upon creating an evenly blended mixture including all the above components, the fifth exemplary urethane based luminescent paint is completed. The amount of time required to make this luminescent paint may vary. In some examples, the total amount of time required to make this luminescent paint may be about 30 minutes.

A sixth exemplary urethane based luminescent paint includes a urethane base, an anti-settling agent, and luminescent substance. In this example, the urethane base is made from scratch rather than utilizing a pre-mixed volume of urethane base which may be purchased over-the-counter. The components used in this example to comprise the urethane base include: Butyl acetate; methyl ethyl ketone; a crosslinker such as Solucote XL-1 manufactured by Soluol, Inc. of Providence, R.I. 02915 or CX-100 manufactured by DSM NeoResins of Wilmington, Mass. 01887; a urethane resin such as Solucote 6010 manufactured by Soluol, Inc.; one or more wetting agents or dispersants such as OT75pg surfactant manufactured by Cytec Industries of Willow Island, W.V. 26134 or 152k sperse dispersant manufactured by King Industries of Norwalk, Conn. 06852; butyl alcohol; toluene; and xylene. Also in the present example, the anti-settling agent may be Y25X anti-settling product manufactured by Southern Clay Products, Inc. Alternatively, the anti-settling agent may be Y-20XP also manufactured by Southern Clay Products, Inc. or Disparlon 4200-20 manufactured by King Industries of Norwalk, Conn. 06852. Further in the present example, the luminescent substance may be strontium aluminate europium and may be one of a variety of products manufactured by MPK Co. Such examples of luminescent substance may be comprised of the following MPK Co. products: MMHSB-8D; MMHSB-9D; MMHSB-9C; MMHG-5B; MMSWW-4D. Alternatively, the present example may include luminescent substance products manufactured by other entities such as WGR1-OW-12-18 manufactured by Color Technology of Howell, N.J. 07731 or MR-1 manufactured by Yangzhou Huahan Plastic Colour Masterbatch Co. Ltd. of Yangzhou City, Jiangsu Province, China.

The urethane based luminescent paint of this sixth example may have a variety of different colors and the compositions of the luminescent paint differ depending on the desired color. Dyes may be added to the urethane based luminescent paint in order to establish a desired color other than white. A variety of different types of dyes may be used to obtain the desired color of the urethane based luminescent paint. The dyes identified below are for exemplary purposes and are not intended to be limiting upon the present invention.

This sixth exemplary urethane based luminescent paint may be applied to a large variety of objects. Exemplary applications in which this sixth luminescent paint may be particularly effective may include, for example, floors, floor boards, light fixtures, walls, stairs, handrails, parking lot indicia, roadway indicia, airport runway indicia, bollards, construction objects such as road cones, barrels, barriers, etc.

The following exemplary colors and compositions are for illustrative purposes only and provide only some of the possible colors and compositions.

If a fluorescent yellow urethane based luminescent paint is desired, the paint may include the following quantities of components: 20 liquid ounces of anti-settling agent, 5 liquid ounces of a crosslinker, 42 liquid ounces of Solucote 6010 urethane resin, 5 liquid ounces of OT75pg surfactant, 5 liquid ounces of 152k sperse dispersant, 15 liquid ounces of butyl acetate, 15 liquid ounces of methyl ethyl ketone, 5 liquid ounces of butyl alcohol, 5 liquid ounces of toluene, 5 liquid ounces of xylene, 6 liquid ounces of 03278 dye manufactured by SEM Products, and 1 kilogram of MMSWW-4D luminescent substance.

If a yellow urethane based luminescent paint is desired, the paint may include the following quantities of components: 20 liquid ounces of anti-settling agent, 5 liquid ounces of a crosslinker, 42 liquid ounces of Solucote 6010 urethane resin, 5 liquid ounces of OT75pg surfactant, 5 liquid ounces of 152k sperse dispersant, 15 liquid ounces of butyl acetate, 15 liquid ounces of methyl ethyl ketone, 5 liquid ounces of butyl alcohol, 5 liquid ounces of toluene, 5 liquid ounces of xylene, 6 liquid ounces of Planet Color PCLD5 dye manufactured by Sherwin-Williams Automotive Finishes Corp., and 1 kilogram of MMSWW-4D luminescent substance.

If an orange urethane based luminescent paint is desired, the paint may include the following quantities of components: 20 liquid ounces of anti-settling agent, 5 liquid ounces of a crosslinker, 42 liquid ounces of Solucote 6010 urethane resin, 5 liquid ounces of OT75pg surfactant, 5 liquid ounces of 152k sperse dispersant, 15 liquid ounces of butyl acetate, 15 liquid ounces of methyl ethyl ketone, 5 liquid ounces of butyl alcohol, 5 liquid ounces of toluene, 5 liquid ounces of xylene, 6 liquid ounces of Planet Color PCLD5 dye manufactured by Sherwin-Williams Automotive Finishes Corp., 16 grams of Parasol Red EG Solvent Red 135 manufactured by Paramount Colors Inc. of Elk Grove Village, Ill. 60007, and 1 kilogram of MMSWW-4D luminescent substance.

An alternative orange urethane based luminescent paint includes similar quantities of components as the previous orange paint, however, this alternative orange paint includes a combination of luminescent substances to arrive at the 1 kilogram of total luminescent substance mass. More particularly, this alternative orange paint includes 0.75 kilograms of MMSWW-4D luminescent substance and 0.25 kilograms of WGR1-OW-12-18 luminescent substance.

In other alternative orange urethane based luminescent paints, other types of dyes may be used to color the paint a desired color. Such dyes may include, for example, Parasol BK 196, Parasol GK 197, Parasol AB23, and Parasol A 24, all of which are manufactured by Paramount Colors Inc. of Elk Grove Village, Ill. 60007.

If a purple urethane based luminescent paint is desired, the paint may include the following quantities of components: 20 liquid ounces of anti-settling agent, 5 liquid ounces of a crosslinker, 42 liquid ounces of Solucote 6010 urethane resin, 5 liquid ounces of OT75pg surfactant, 5 liquid ounces of 152k sperse dispersant, 15 liquid ounces of butyl acetate, 15 liquid ounces of methyl ethyl ketone, 5 liquid ounces of butyl alcohol, 5 liquid ounces of toluene, 5 liquid ounces of xylene, 4 liquid ounces of 03238 dye manufactured by SEM Products, 2 liquid ounces of Planet Color PCLD8 dye manufactured by Sherwin-Williams Automotive Finishes Corp., 0.75 kilograms of MMHSB-9D luminescent substance, and 0.25 kilograms of WGR1-OW-12-18 luminescent substance.

If a red urethane based luminescent paint is desired, the paint may include the following quantities of components: 20 liquid ounces of anti-settling agent, 5 liquid ounces of a crosslinker, 42 liquid ounces of Solucote 6010 urethane resin, 5 liquid ounces of OT75pg surfactant, 5 liquid ounces of 152k sperse dispersant, 15 liquid ounces of butyl acetate, 15 liquid ounces of methyl ethyl ketone, 5 liquid ounces of butyl alcohol, 5 liquid ounces of toluene, 5 liquid ounces of xylene, 16 grams of Parasol Red PH manufactured by Paramount Colors Inc. of Elk Grove Village, Ill. 60007, 0.30 kilograms of WGR1-OW-12-18 Color Technology luminescent substance, and 0.70 kilograms of MR-1 Yangzhou Huahan Plastic Colour Masterbatch luminescence substance.

In alternative red urethane based luminescent paints, other types of dyes may be used to color the paint a desired color. Such dyes may include, for example, Parasol BK 196, Parasol GK 197, Parasol AB23, and Parasol A 24, all of which are manufactured by Paramount Colors Inc. of Elk Grove Village, Ill. 60007.

Similar to the first exemplary urethane based paint described above, this sixth exemplary urethane based paint and all of its colors described above may, in some exemplary embodiments, include another substance or filler in order to provide additional beneficial characteristics to the sixth exemplary urethane based luminescent paint. The remarks above pertaining to the filler added to the first exemplary urethane based paint also apply to the sixth exemplary urethane based luminescent paint and, for the sake of brevity, will not be repeated here.

In the above exemplary colors of the sixth exemplary urethane based luminescent paint, the various elements of the paint comprise the following percentages of the total weight of the paint: urethane base comprises between about 51% and about 75% of the total weight; anti-settling agent comprises between about 10% and about 13% of the total weight; dye comprises between 3% and about 4% of the total weight; luminescent substance comprises between about 17% and about 23% of the total weight; and filler comprises between 0% and about 18%. Alternatively, the various elements of the paint may comprise other percentages of the total weight of the urethane based luminescent paint. For example, the various elements may comprise the following percentages of the total weight of the paint: urethane base may comprise between about 24% and about 95% of the total weight; anti-settling agent may comprise between about 7% and about 17% of the total weight; dye may comprise between 0% and about 10% of the total weight; luminescent substance may comprise between about 10% and about 35% of the total weight; and filler may comprise between 0% and about 35%. In the sixth exemplary embodiment, the urethane base is comprised of a variety of exemplary elements, each of which comprise a percentage of the total weight of the urethane based luminescent paint. For example, the elements of the urethane base and their percentages of the total weight of the paint are as follows: crosslinker comprises between about 2% and about 4% of the total weight; urethane resin comprises between about 21% and about 26% of the total weight; surfactant comprises between about 2% and about 4%; dispersant comprises between about 2% and about 4%; butyl acetate comprises between about 7% and about 10%; methyl ethyl ketone comprises between about 7% and about 10%; butyl alcohol comprises between about 2% and about 4% of the total weight; toluene comprises between about 2% and about 4% of the total weight; and xylene comprises between about 2% and about 4% of the total weight.

Another manner in which to consider the sixth exemplary urethane based paint is by the elements that comprise solvents and the elements that comprise non-solvents. In this sixth example, the solvents comprise surfactant, dispersant, butyl acetate, methyl ethyl ketone, butyl alcohol, toluene, and xylene, and the non-solvents comprise the anti-settling agent, urethane resin, crosslinker, dye, luminescent substance, and filler. The solvents and non-solvents used in this exemplary urethane based paint are exemplary and a variety of other solvents and non-solvents may be used with the urethane based luminescent paint and still be within the spirit and scope of the invention. In this sixth exemplary urethane based luminescent paint, the solvents in combination comprise between about 27% and about 34% of the total weight, and the non-solvents comprise between about 66% and about 73% of the total weight. Alternatively, the solvents and non-solvents may comprise other percentages of the total weight of the urethane based luminescent paint. For example, the solvents in combination may comprise between about 20% and about 70% of the total weight of the paint. Also, for example, the non-solvents in combination may comprise between about 30% and about 80% of the total weight of the paint. Additionally, the non-solvents may be parsed into individual elements and may include the following percentages of the total weight of the paint: anti-settling agent may comprise between about 7% and about 17% of the total weight; urethane resin may comprise between about 15% and about 37% of the total weight; crosslinker may comprise between about 0.3% and about 6% of the total weight; dye may comprise between about 0% and about 10% of the total weight; luminescent substance may comprise between about 10% and about 35% of the total weight; and filler may comprise between 0% and about 35%.

This sixth exemplary urethane based luminescent paint may be made in a variety of different methods. In one example, this sixth exemplary paint may be made in the same manner as the fifth exemplary urethane based luminescent paint illustrated in FIG. 8. Accordingly, reference is made to FIG. 8 where one of the many exemplary methods of making this sixth exemplary urethane based luminescent paint is illustrated. This is only one of many different methods of making the sixth exemplary paint and this example is not intended to be limiting. Many other methods of making the sixth exemplary urethane based luminescent paint are contemplated and are within the spirit and scope of the present invention.

It should be understood that the six previously described methods of making the six exemplary urethane based luminescent paints are for exemplary purposes only and that the components of the paints can be mixed in different quantities and in different orders and still be within the spirit and scope of the present invention. For example, dye may be added at anytime during the paint making process of the above exemplary urethane based luminescent paints. Also, for example, in the process of making the second exemplary urethane based luminescent paint, the flex agent may be added at any time during the process. Additionally, for example, if filler is desired, the filler may be added at any time after the addition of the luminescent substance. Further, for example, various quantities of the components may be added to the mixture at various times throughout the paint making process.

The six exemplary urethane based luminescent paints described above have different characteristics relative to one another. One such characteristic difference is the quantity of solids per total weight present in the luminescent paints. For example, the first and second exemplary urethane based luminescent paints may comprise between about 52% and about 58% solids, the third exemplary urethane based luminescent paint may comprise between about 40% and about 46% solids, the fourth exemplary urethane based luminescent paint may comprise between about 38% and about 44% solids, and the fifth and sixth exemplary urethane based luminescent paints may comprise between about 46% and about 52% solids. Alternatively, the various urethane based luminescent paints may comprise other percentages of solids. For example, the first and second exemplary urethane based luminescent paints may comprise between about 42% and about 68% solids, the third exemplary urethane based luminescent paint may comprise between about 30% and about 56% solids, the fourth exemplary urethane based luminescent paint may comprise between about 28% and about 54% solids, and the fifth and sixth exemplary urethane based luminescent paints may comprise between about 36% and about 62% solids.

The remaining percentage of content in these paints is comprised of evaporative (e.g., solvents). Such evaporative may be categorized as a volatile organic compounds (VOC) and/or a hazardous air pollutant (HAP), both of which have been considered by some scientists to be adverse to the environment. Accordingly, the larger the percentage of solids in a paint, the lower the quantity of VOCs and/or HAPs in the paint and the more friendly the paint is to the environment. When the evaporative evaporates, the solids remain. Therefore, a higher content percentage of solids in a paint, the more paint that remains after evaporation. With more paint present on an object, the paint remains on the object longer and is able to undergo more impact, thereby providing a more durable paint.

The foregoing description has been presented for purposes of illustration and description, and is not intended to be exhaustive or to limit the invention to the precise form disclosed. The descriptions were selected to explain the principles of the invention and their practical application to enable others skilled in the art to utilize the invention in various embodiments and various modifications as are suited to the particular use contemplated. Although particular constructions of the present invention have been shown and described, other alternative constructions will be apparent to those skilled in the art and are within the intended scope of the present invention.

What is claimed is:

1. A luminescent paint composition comprising:
urethane resin; and
luminescent substance.

2. The luminescent paint composition of claim 1, further comprising a flex agent.

3. The luminescent paint composition of claim 1, further comprising an anti-settling agent.

4. The luminescent paint composition of claim 3, further comprising a flex agent.

5. The luminescent paint composition of claim 1, further comprising a filler.

6. The luminescent paint composition of claim 5, wherein the filler is comprised of at least one of silica flour and nepheline syenite.

7. The luminescent paint composition of claim 1, further comprising:
anti-settling agent; and
filler;
with a balance of the luminescent paint composition comprising at least one solvent.

8. The luminescent paint composition of claim 7, wherein the at least one solvent is comprised of at least one of butyl acetate, butyl alcohol, toluene, xylene, and methyl ethyl ketone.

9. The luminescent paint composition of claim 1, further comprising:
anti-settling agent;
flex agent; and
filler;
with a balance of the luminescent paint composition comprising at least one solvent.

10. The luminescent paint composition of claim 1, further comprising:
anti-settling agent;
dye; and
filler;
with a balance of the luminescent paint composition comprising at least one solvent.

11. The luminescent paint composition of claim 1, further comprising:
anti-settling agent; and
dye;
with a balance of the luminescent paint composition comprising at least one solvent.

12. A luminescent paint having a composition comprising, as a percentage by weight:
about 10% to about 37% urethane resin; and
about 10% to about 35% luminescent substance.

13. The luminescent paint of claim 12, wherein the percentage by weight of urethane resin is about 15% to about 27%.

14. The luminescent paint of claim 12, wherein the percentage by weight of luminescent substance is about 17% to about 23%.

15. The luminescent paint of claim 12, wherein the composition further comprises, as a percentage by weight, about 7% to about 35% anti-settling agent.

16. The luminescent paint of claim 15, wherein the percentage by weight of anti-settling agent is about 10% to about 20%.

17. The luminescent paint of claim 15, wherein the composition further comprises, as a percentage by weight, about 0.3% to about 12% flex agent.

18. The luminescent paint of claim 17, wherein the percentage by weight of flex agent is about 5% to about 7%.

19. The luminescent paint of claim 12, wherein the composition further comprises, as a percentage by weight, about 0.3% to about 12% flex agent.

20. The luminescent paint of claim 19, wherein the percentage by weight of flex agent is about 5% to about 7%.

21. The luminescent paint of claim 12, wherein the composition further comprises, as a percentage by weight, about 0.5% to about 35% filler.

22. The luminescent paint of claim 21, wherein the percentage by weight of filler is about 0.5% to about 18%.

23. The luminescent paint of claim 21, wherein the filler is comprised of at least one of silica flour and nepheline syenite.

24. A luminescent paint having a composition comprising, as a percentage by weight:
about 15% to about 27% urethane resin;
about 10% to about 20% anti-settling agent;
about 0.2% to about 4% dye; and
about 17% to about 23% luminescent substance.

25. The luminescent paint of claim 24, wherein the composition further comprises, as a percentage by weight, about 0.5% to about 18% filler.

26. The luminescent paint of claim 24, wherein the composition further comprises, as a percentage by weight, about 5% to about 7% flex agent.
